(19) United States
(12) Patent Application Publication
(10) Pub. No.: US 2015/0086190 A1
(43) Pub. Date: Mar. 26, 2015

(54) LIGHT-QUANTITY CONTROL APPARATUS AND OPTICAL APPARATUS

(71) Applicant: CANON DENSHI KABUSHIKI KAISHA, Chichibu-shi (JP)

(72) Inventors: Satoshi Kozu, Tokyo (JP); Kotaku Sato, Kawaguchi-shi (JP)

(21) Appl. No.: 14/557,564

(22) Filed: Dec. 2, 2014

Related U.S. Application Data
(63) Continuation of application No. PCT/JP2013/003579, filed on Jun. 6, 2013.

(30) Foreign Application Priority Data
Jun. 6, 2012 (JP) 2012-128808
Dec. 17, 2012 (JP) 2012-274970
Dec. 27, 2012 (JP) 2012-285712
Dec. 27, 2012 (JP) 2012-286350
Jan. 9, 2013 (JP) 2013-001553

(51) Int. Cl. G03B 9/54

(52) U.S. Cl. CPC G03B 9/54
USPC 396/462

(57) ABSTRACT

A light-quantity control apparatus includes a light-quantity control blade movable along a curved path preformed between a first optical member and a second optical member, and a blade driver configured to rotate the light-quantity control blade along the curved path. A light-quantity control apparatus includes a light-quantity control blade movable along a curved path preformed between a first optical member and a second optical member, and a blade driver configured to rotate the light-quantity control blade along the curved path. The blade driver includes a rotating member configured to rotate the light-quantity control blade, and a driver connected to an outer circumferential edge portion of the rotating member.

### CROSS-REFERENCE TO RELATED APPLICATIONS

This application is a continuation of International Patent Application No. PCT/JP2013/003579, filed on Jun. 6, 2013 which is hereby incorporated by reference herein in its entirety as if fully set forth herein.

### BACKGROUND OF THE INVENTION

1. Field of the Invention

The present invention relates to a light-quantity control apparatus and an optical apparatus having the light-quantity control apparatus. The light-quantity control apparatus is installed in an optical apparatus such as a digital camera, a video camera and an interchangeable lens.

2. Description of the Related Art

An optical apparatus such as a camera is necessary to have compactness. In particular, when a lens barrel for holding an image capturing lens protrudes from a camera body in its optical axis direction, it is necessary to reduce a length of the lens barrel in the optical axis direction as short as possible. Japanese Patent Laid-Open No. 2007-310412 discloses a camera having a so-called retractable lens barrel that protrudes from a camera body during a camera use time (image capturing) and is housed (retracted) to the camera body during a camera non-use time (carrying). In this camera, an aperture stop serving as the light-quantity control apparatus and a lens are arranged adjacently to each other in an optical axis direction. Therefore, the length of the lens barrel in the retracted state is reduced by inserting a part of the lenses into the aperture in the retracted state.

However, in the camera disclosed in Japanese Patent Laid-Open No. 2007-310412, the part of the lenses is inserted into the aperture formed by opening a stop blade more than its fully opened state. For this reason, a diameter of the fully opened aperture is required to be larger than an outer diameter of the lenses. This requires an increase in size of the stop blade forming the stop aperture and accordingly of an outer circumferential space into which the stop blade opened more than its fully opened state is to be retracted. This results in an increase in size of the light-quantity control apparatus, making it difficult to miniaturize the camera in which the light-quantity control apparatus is installed.

### SUMMARY OF THE INVENTION

The present invention provides a light-quantity control apparatus that can be appropriately miniaturized. The present invention further provides an optical apparatus in which the light-quantity control apparatus is installed.

The present invention provides as an aspect thereof a light-quantity control apparatus. The light-quantity control apparatus includes a light-quantity control blade movable along a curved path preformed between a first optical member and a second optical member, and a blade driver configured to rotate the light-quantity control blade along the curved path.

The present invention provides as another aspect thereof a light-quantity control apparatus. The light-quantity control apparatus includes a light-quantity control blade movable along a curved path preformed between a first optical member and a second optical member, and a blade driver configured to rotate the light-quantity control blade along the curved path. The blade driver includes a rotating member configured to rotate the light-quantity control blade and a driver connected to an outer circumferential edge portion of the rotating member.

The present invention provides as another aspect thereof a light-quantity control apparatus provided with a light-passing aperture. The apparatus includes a base member, a light-quantity control blade including a light-quantity control portion to control quantity of light passing through the light-passing aperture and a supported portion rotatably supported with respect to the base member, and a rotating member rotating with respect to the base member to rotate the light-quantity control blade. When a direction orthogonal to an aperture plane of the light-passing aperture is defined as an optical axis direction, a concave space facing the light-passing aperture is formed more inside in a direction orthogonal to the optical axis direction than the light-quantity control blade, the rotating member includes gear tooth serving as a driving mechanism, and the gear tooth constitute part of a wall portion surrounding the concave space.

The present invention can realize a light-quantity control apparatus that can be appropriately miniaturized. In particular, a light-quantity control blade of the light-quantity control apparatus requires a smaller space in a radial direction when opened to its fully opened state. This configuration makes it possible to miniaturize the light-quantity control apparatus in the radial direction, which enables achieving miniaturization of an optical apparatus in which the light-quantity control apparatus is installed.

Other aspects of the present invention will become apparent from the following description and the attached drawings.

### BRIEF DESCRIPTION OF THE DRAWINGS

FIG. 1 is an exploded perspective view illustrating an aperture stop apparatus that is Embodiment 1 of the present invention.

FIGS. 2A and 2B are rear views illustrating the aperture stop apparatus of Embodiment 1 and an enlarged view of an anti-shake mechanism used in the aperture stop apparatus of Embodiment 4.

FIG. 3 is a side cross-sectional view illustrating the aperture stop apparatus of Embodiment 1.

FIGS. 4A and 4B are explanatory diagrams illustrating operations of the aperture stop apparatus of Embodiment 1.

FIG. 5 is a perspective view illustrating the stop blade used in the aperture stop apparatus of Embodiment 1.

FIG. 6 is an exploded perspective view illustrating an aperture stop/shutter apparatus that is Embodiment 2 of the present invention.

FIGS. 7A and 7B are rear perspective views illustrating the aperture stop/shutter apparatus of Embodiment 2.

FIG. 8 is a side cross-sectional view illustrating the aperture stop/shutter apparatus of Embodiment 2.

FIGS. 9A and 9B are perspective views illustrating a stop blade and a shutter blade used in the aperture stop/shutter apparatus of Embodiment 2.

FIGS. 10A and 10B are explanatory diagrams illustrating operations of the stop blade in Embodiment 2.

FIGS. 11A and 11B are explanatory diagrams illustrating operations of the shutter blade in Embodiment 2.

FIG. 12 is an enlarged view of outer circumferential side in another variation of Embodiment 2.

FIG. 13 is an exploded perspective view illustrating an aperture stop apparatus that is Embodiment 3 of the present invention.

FIG. 14 is a perspective view illustrating an aperture stop apparatus in Embodiment 3.

FIGS. 15A and 15B are internal structure views illustrating an aperture stop apparatus in Embodiment 3.

FIG. 16 is an arrangement view of a lens barrel illustrating an aperture stop apparatus in Embodiment 3.

FIG. 17 is a perspective view illustrating a stop blade used in an aperture stop apparatus in Embodiment 3.

FIGS. 18A, 18B and 18C are explanatory diagrams illustrating operations of the aperture stop apparatus of Embodiment 3.

FIG. 19 is a perspective view illustrating an internal structure of an aperture stop apparatus in Embodiment 3.

FIG. 20 is an exploded perspective view illustrating an aperture stop apparatus that is Embodiment 4 of the present invention.

FIG. 21 is a perspective view illustrating an aperture stop apparatus in Embodiment 4.

FIGS. 22A and 22B are side cross-sectional views illustrating the aperture stop apparatus of Embodiment 4.

FIG. 23 is a side cross-sectional view illustrating the aperture stop apparatus of the comparative example.

FIG. 24 is a rear view illustrating an anti-shake mechanism used in the aperture stop apparatus of Embodiment 4.

FIG. 25 is a perspective view illustrating the aperture stop blade of the light-quantity control mechanism used in the aperture stop apparatus of Embodiment 4.

FIGS. 26A and 26B are explanatory diagrams illustrating operations of the stop blade used in the aperture stop apparatus of Embodiment 4.

FIGS. 27A and 27B are front views illustrating the stop blade used in an aperture stop apparatus that is Embodiment 5 of the present invention.

FIGS. 28A and 28B are block diagrams illustrating a configuration of a camera provided with the aperture stop apparatus of Embodiments 1 and 3, the aperture stop/shutter apparatus of Embodiment 2, and the aperture stop apparatus of Embodiments 5 and 6.

### DESCRIPTION OF EMBODIMENTS

Exemplary embodiments of the present invention will hereinafter be described with reference to the accompanying drawings.

### Embodiment 1

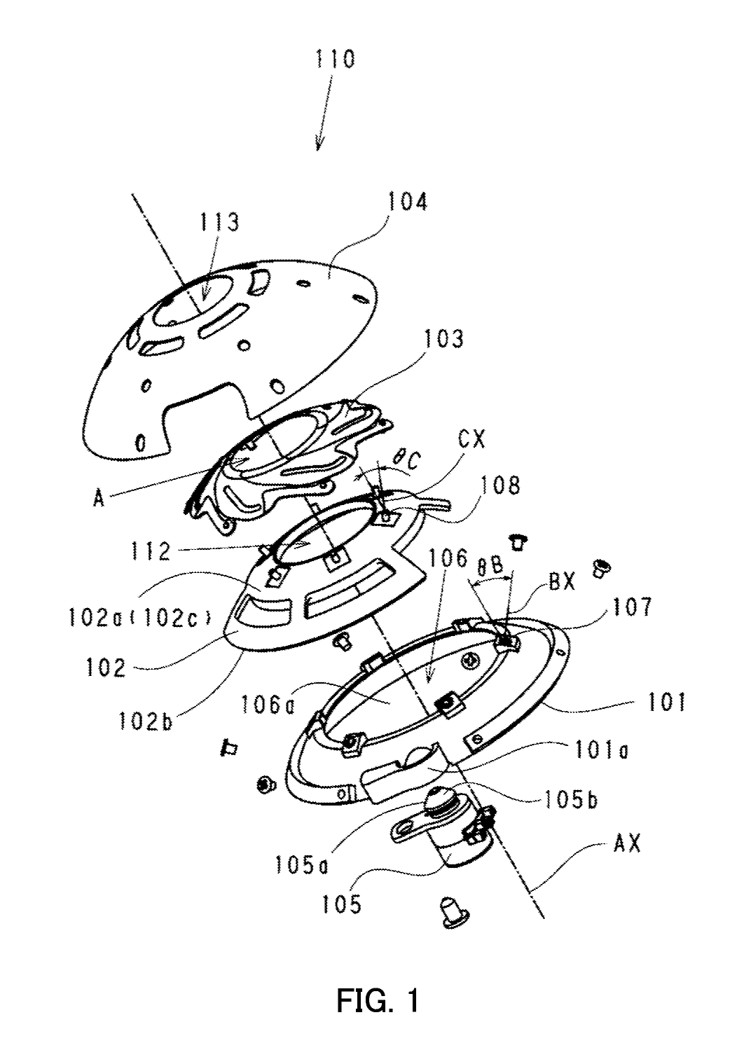

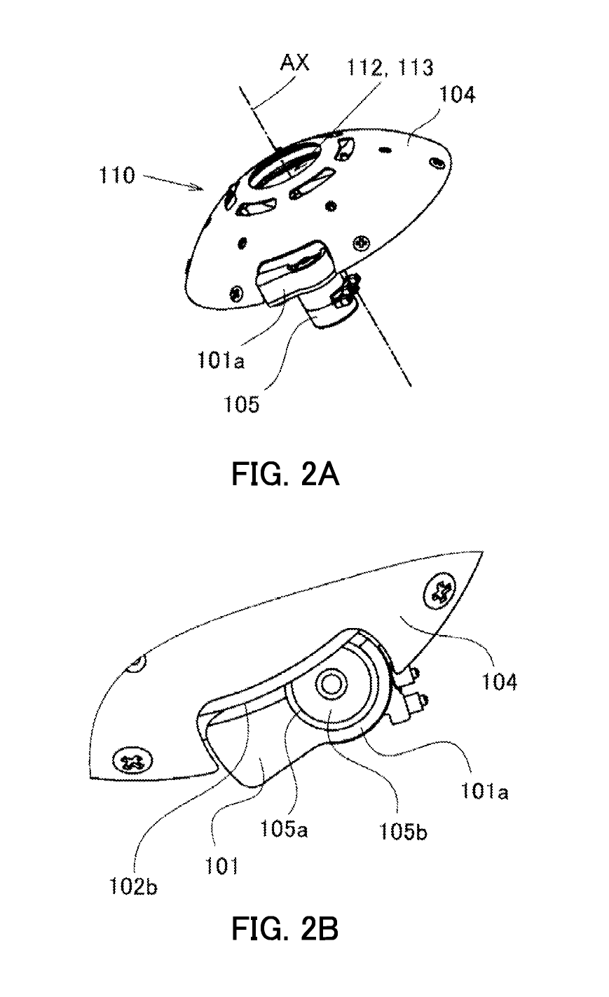

FIGS. 1, 2A and 2B illustrate an iris type aperture stop apparatus 110 as a light-quantity control apparatus that is Embodiment 1 of the present invention. FIG. 2A is a rear perspective view of the aperture stop apparatus 110. FIG. 2B is an enlarged view of a connecting portion of a rotating member and a driver of the aperture stop apparatus 110. In the drawings, reference numeral 101 denotes a base plate serving as a base member. A first fixed aperture 106 is formed at a diametric center portion of the base plate 101. A mounted portion 101a is mounted on the base plate 101 at a position where gear tooth of the driver and gear tooth of the rotating member, both described later, engage with each other. At a circumferential edge portion of the mounted portion 101a, a continuous curved surface shape of the base plate 101 is provided to connect the gear tooth, which will be described later, thereto so as to prevent the gear from, when being rotated, contacting with the base plate 101 near the mounted portion 101a. In the following description, an axis that passes through an aperture plane 106a of the first fixed aperture 106 and is orthogonal to the aperture plane 106a is referred to as “an optical axis AX,” and a direction in which the optical axis AX extends is referred to as “an optical axis direction”.

In addition, a supporting hole portion (concave portion) 107 as a supporting portion is formed at each of a plurality of circumferential places of a ring portion surrounding the first fixed aperture 106 of the base plate 101. A center axis BX of each supporting portion 107 has a tilt angle θB with respect to the optical axis direction (optical axis AX).

A driving ring 102 serves as a driving member. The driving ring 102 has a domical wall portion 102a formed in a domical shape concave toward the base plate 101 (first fixed aperture 106) (in other words, formed so as to have a shape concave toward one side in the optical axis direction from its outer circumferential side portion to its inner circumferential side portion).

A driven gear 102b is formed in a circumferential part of an outer circumferential side portion of the driving ring 102 than the domical wall portion 102a. In the domical wall portion 102a, a concave surface on a base plate (101) side and a convex surface (hereinafter, referred to as “a guide surface”) 102c on an opposite side thereto, and the driven gear 102b are respectively formed in a spherical surface shape. That is, in the end portion of the outer circumferential side portion along the curved surface shape of the domical wall portion 102a of the curved surface shape, a gear tooth of cover drive gear 102b which has a tilt with respect to the optical axis is established. A second fixed aperture 112 corresponding to a fully opened aperture is formed in a radially central part of the domical wall portion 102a. A position of an aperture plane of the second fixed aperture 112 in the optical axis direction is distant from the base plate 101 (that is, the aperture plane 106a of the first fixed aperture 106) as compared to the outer circumferential portion of the domical wall portion 102a of the aperture-stop driving ring 102.

The driver, which will be described later, is disposed on the mounted portion 101a provided at an outer circumferential edge portion of the base plate 101. The disposition of the driver on the mounted portion 101a provided by recessing the outer circumferential edge portion of the base plate 101 enables miniaturizing the aperture stop apparatus 110 in the optical axis direction. Furthermore, providing the mounted portion 101a by recessing a curved portion of the base plate 101 enables miniaturizing the aperture stop apparatus 110 in a direction orthogonal to the optical axis direction. That is, the provision of the mounted portion 101a to a recess part of the outer circumferential edge portion of the base plate 101 results in the disposition of the mounted portion 101a on a first fixed aperture (106) side. This enables reducing a portion that protrudes from the outer circumferential edge portion of the base plate 101, which makes it possible to miniaturize the entire aperture stop apparatus 110.

In addition, a boss portion 108 is formed at each of a plurality of circumferential places of the stop guide surface 102c (circumferential places around the second fixed aperture 112) of the domical wall portion 102a. A center axis CX of each boss portion 108 has a tilt angle θC with respect to the optical axis direction (optical axis AX) extending in a direction normal to the stop guide surface 102c and substantially intersects with the optical axis AX.

Reference numeral 103 denotes stop blades as a plurality of light-quantity control blades (light-blocking blades). Each stop blade 103 is constituted by a plate member bent along a lens surface. For instance, in this embodiment, each stop blade 103 is a bent thin plate member having a light-blocking property for forming, radially inside the first fixed aperture 106 of the base plate 101 and the second fixed aperture 112 of the driving ring 102, a stop aperture (light-passing aperture) A whose circumference is a light-blocking area.

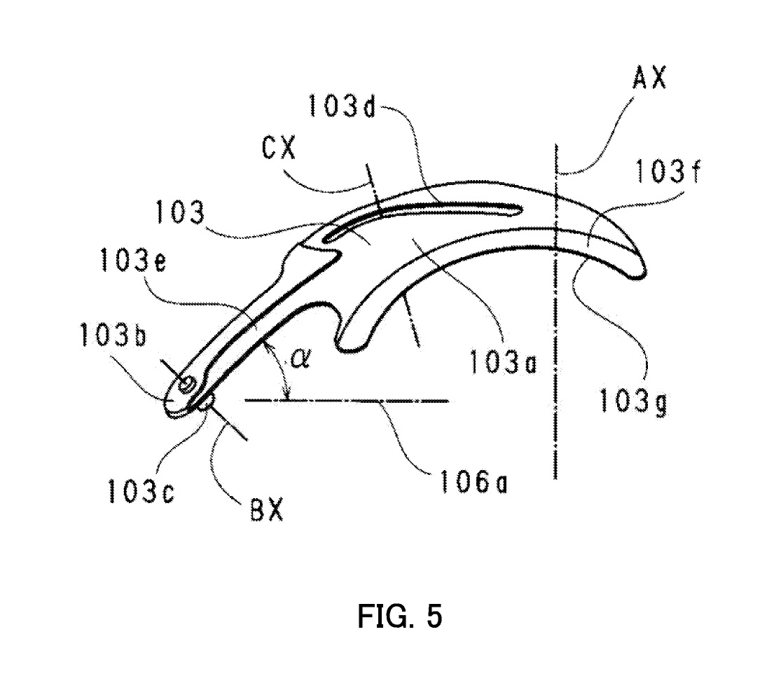

As illustrated in FIG. 5, each stop blade 103 includes a light-blocking portion 103a as a light-quantity control portion for forming the stop aperture A, a stop blade-supported portion 103b rotatably supported with respect to the base plate 101 and the driving ring (part of a blade driver) 102 and an intermediate portion 103e that connects the light-blocking portion 103a and the stop blade-supported portion 103b. On the stop blade-supported portion 103b, a boss portion (protruding portion) 103c is formed that is inserted into the supporting hole portion 107 formed on the base plate 101. Each stop blade 103 is thus rotatable about the supporting hole portion 107 and the boss portion 103c with respect to the base plate 101 and the driving ring 102. In addition, a direction of a stop blade-supported surface (abutted surface) of the stop blade-supported portion 103b provided with the boss portion 103c matches with a direction of a center axis (rotational axis) BX.

Each of the plurality of stop blades 103 is disposed so as to face the guide surface 102c of the domical wall portion 102a of the driving ring 102. The light-blocking portion 103a is formed in a spherical surface shape (curved surface shape) having a curvature substantially the same as that of the guide surface 102c of the domical wall portion 102a of the driving ring 102. For this reason, when each stop blade 103 is rotated, the light-blocking portion 103a is moved in a direction to advance and retract into and from a radially inside area of the second fixed aperture 112 (area facing the first and second fixed apertures 106 and 112), that is, a direction to change a size of the stop aperture A while moved along the guide surface 102c, in other words, by being guided by the guide surface 2c to control quantity of light passing through the first and second fixed apertures 106 and 112. The above advancing/retracting direction is hereinafter referred to as “a stop opening/closing direction.” Between the base plate 101 and the driving ring 102, a step is provided such that the driving ring 102 is convex and the outer circumferential side portion is lower than the driving ring 102. Since the driving ring 102 is convex, each stop blade 103 can be smoothly moved without caught by the outer circumferential portion.

Furthermore, on the light-blocking portion 103a, a cam groove portion 103d is formed into which the boss portion 108 formed in the driving ring 2 is inserted and with which the boss portion 108 is engaged. When each light-blocking blade is manufactured by molding, press molding or the like, an angle of the abutted surface of the cam groove portion 103d has a certain value because a draft direction of a mold is fixed. The rotation of each light-quantity control blade 103 is restricted (limited) by the abutted surface of the cam groove portion 103d (rotation restricting portion) against which the boss portion 108 abuts, which enables more stable precision operations compared to a case where each light-quantity control blade 103 is rotated while supported at one point. The abutted surface of the cam groove portion 103d against which the boss portion 108 abuts serves as a restricting surface that restricts the rotation of each light-quantity control blade 103. A direction of the restricting surface (abutted surface direction) matches with a direction indicated by symbol BX. As described above, the center axis CX of each boss portion 108 extends in a direction normal to the guide surface 102c. This enables each boss portion 108 to more smoothly move in the cam groove portion 103d, compared to a case where the center axis CX extends in the optical axis direction, which allows each boss portion 108 to rotate the light-blocking portion 103a (i.e., the stop blade 103) with good position accuracy.

Each light-quantity control blade of this embodiment described above is rotated on the spherical surface (curved surface) in order to effectively use a curved space between optical members. In a configuration for enabling this, a facing direction of the stop blade-supported surface (abutted surface) of the stop blade-supported portion 103b on which the above-described boss portion 103c is provided (a direction of the center axis BX of the rotation (rotational axis)) substantially intersects with a direction of the center axis BX of each supporting hole portion 107. This means that the direction of the stop blade-supported surface of the stop blade-supported portion 103b and the direction of the restricting surface of the cam groove portion 103d serving as a rotation restring portion substantially intersect with each other. That is, each light-quantity control blade 103 of this embodiment is provided such that the direction of the stop blade-supported surface of the stop blade-supported portion 103b and the direction of the restricting surface of the cam groove portion 103d substantially intersect with each other with respect to the optical axis direction (AX direction). This means that the direction of the stop blade-supported surface of the stop blade-supported portion 103b and the direction of the restricting surface of the cam groove portion 103d intersect with each other or are the closest to each other at a point on an extension of the optical axis AX, the center axis BX and the center axis CX and that a spherical center of a spherical-shaped orbit on which each light-quantity control blade 103 is rotated is located near the point. Each light-quantity control blade 103 of this embodiment having such a configuration can be smoothly and stably opened and closed even though curved along the lens surface. In other words, each light-quantity control blade 103 in this embodiment can be smoothly and stably opened and closed and moreover requires a smaller installation space in the light-quantity control apparatus, which is highly advantageous for miniaturizing the light-quantity control apparatus.

On the other hand, when a tilt of the cam groove portion 103d is set to an inappropriate value, the cam groove portion 103d is likely to be caught by the boss portion 108 at the time of the rotation of the driving ring 102. Setting the draft direction of the mold to a direction near a center of a range within which the cum is operated in order to set a section angle of the cam groove portion 103d to an optimum value makes it possible to minimize a difference between an angle of the cam groove portion 103d and that of the cum boss portion 108. In addition, an increase in thickness of the intermediate portion 103e results in an improvement in strength of the stop blade 103, which enables more accurate operation of the stop blade 103. It is noted that an alternative configuration may be employed in which the light-blocking portion 103a is formed in the spherical surface shape and in which the guide surface 102c is formed not in the spherical surface shape, but in a truncated conical surface shape.

In a case where each stop blade 103 is to be formed by injection molding, a molten plastic is injected to a cavity from a sprue of the mold through a gate. The higher thickness of the intermediate portion 103e of each stop blade 103, which is formed as a plastic-molded product, than that of the light-quantity control portion 103a results in an increase in strength of each stop blade 103. In addition, presence of the gate provided near the stop blade-supported portion 103b having the higher thickness than that of the light-quantity control portion 103 lowers a possibility of breakage of a thin portion of each stop blade 103. Moreover, presence of the gate provided on a back surface of the supporting boss portion 103c near the stop blade-supported portion 103b enables a smooth rotation operation of each stop blade 103.

Of each stop blade 103, the intermediate portion 103e and the stop blade-supported portion 103b, namely, a portion on a stop blade-supported portion (103b) side than the light-blocking portion 103a has a tilt α in the optical axis direction with respect to the aperture plane 106a of the first fixed aperture 106 formed on the base plate 101 (such portion has the tilt α with respect also to the aperture plane of the second fixed aperture 112 formed in the driving ring 102 and of a third fixed aperture formed in a cover plate described later). The tilt α is an angle of certain degrees including 90°. Giving the tilt α to the intermediate portion 103e and the stop blade-supported portion 103b causes the light-blocking portion 103a to be located distant from the stop blade-supported portion 103b in the optical axis direction. A center axis of the boss portion 103c formed on the stop blade-supported portion 103b has a tilt with respect to the optical axis AX so as to match with the center axis BX of the supporting hole portion 107. For this reason, each stop blade 103 can be smoothly rotated, compared to a case where the center axis BX of the supporting hole portion 107 extends in the optical axis direction.

It is noted that, in each stop blade 103, the stop blade-supported portion 103b has a larger tilt in the optical axis direction with respect to the aperture plane 106a than that of the light-blocking portion 103a. The entire part from the stop blade-supported portion 103b to the light-blocking portion 103a of each stop blade 103 may be formed in the spherical surface shape (curved surface shape).

Incidentally, a taper 103f is provided to each stop blade 103 such that each stop blade 103 becomes gradually thinner toward a ridgeline 103g. The provision of the taper 103f to each stop blade 103 makes it possible to reduce a hump amount in a narrowly opened state. It is noted that the taper 103f may be provided on either of the outside or the inside of the curved surface shape of each stop blade 103.

In FIGS. 1, 2A and 2B, a cover plate (stop cover member) 104 forms a stop blade room for housing the driving ring 102 and each stop blade 103 between the cover plate 104 and the base plate 101. On an inner circumferential portion of the cover plate 104, a domical shape concave toward the base plate 101 is formed. On the cover plate 104 formed in the curved surface shape, a recess part is provided at a position corresponding to each mounted portion 101a. This makes it easy to check the engagement of the gear tooth of the driving ring 102 with the gear tooth of the driver, which enables an improvement in assembly accuracy. This makes it easy to check the engagement of the gear tooth of the driving ring 102 with the gear tooth of the driver without removing the cover plate 104.

An outer portion of the cover plate 104 is coupled with the base plate 101 by fixing means such as screws, and is thereby integrated with the base plate 101. For this reason, the cover plate 104 can be treated also as the base member similarly to the base plate 101. It is noted that a configuration in which a domical portion similar to the domical portion 104a is formed on the base plate 101 with an original position of the base plate 101 and that of the cover plate 104 exchanged allows each stop blade 103 to be rotated over the curved surface of the other side of the base plate 101, each stop blade 103 can be smoothly moved in a space surrounded by the curved surfaces.

Reference numeral 105 denotes the driver including the actuator such as a stepping motor. A driving gear 105a to be engaged with the driven gear 102b of the driving ring 102 is fixed to the output shaft of the driver 105. To the driving gear 105a, a gear tooth 105b to be engaged with the driven gear 102b is provided. As illustrated in FIG. 2B, the gear tooth of the driven gear 102b facing toward the base plate (101) side is engaged with the gear tooth 105b so as to cover the gear tooth 105b of the driving gear 105a. That is, in the recess part of the base plate 101, the rotating member 102 and the driver 105 face each other in the optical axis direction and are connected to each other. Since the driven gear 102b is formed in the spherical shape, the driving gear 105a and the driven gear 102b are each formed as a hypoid gear or a gear similar thereto. The driver 105 (stop driver) is provided so as to protrude in a direction opposite to a direction in which the domical shape of the cover plate 104 protrudes. This configuration in which the direction in which the domical shape of the cover plate 104 protrudes from the base member and the direction in which the driver 105 protrudes from the base member are opposite to each other enables, when the aperture stop apparatus 110 is installed in the optical apparatus such as the camera, effectively using a space in the optical apparatus (in particular, a space at a side opposite to a side on which the domical shape of the cover plate 104 is disposed), which enables miniaturizing the optical apparatus.

When the driver 105 is energized and thereby the driving gear 105a is rotated, as illustrated in FIGS. 4A and 4B, a rotational force from the driver 105 is transmitted to the stop driving ring 102 through the driven gear 102b and rotates the stop driving ring 102 about the optical axis AX (around the light-passing aperture) with respect to the base plate 101. With the rotation of the stop driving ring 102, the boss portion 8 provided in the stop driving ring 102 moves in the cam groove portion 103d formed in the light-blocking portion 103a of each stop blade 3. Therefore, each stop blade 103 is rotated in the stop opening/closing direction about the boss portion 103c and the supporting hole portion 107 into which the boss portion 103c is inserted.

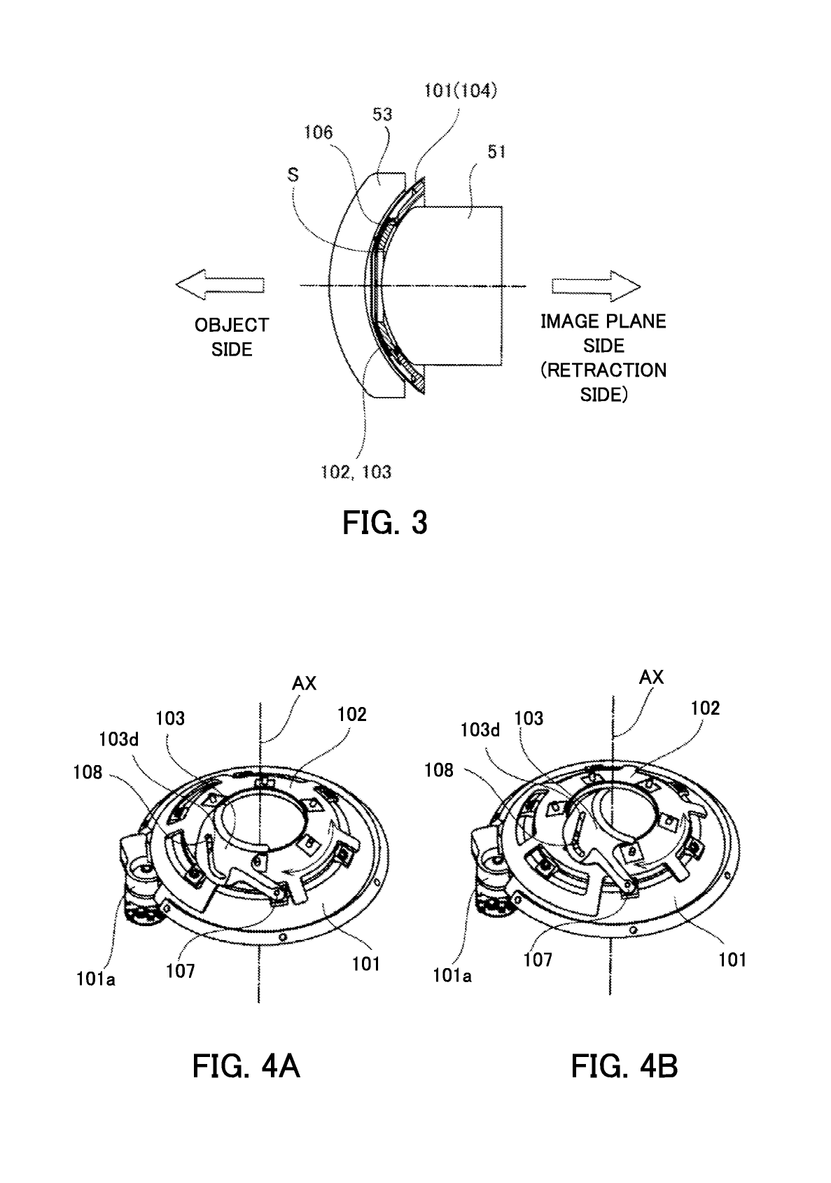

Each stop blade 103 is movable along a curved path preformed between a lens 51 with a convex shape as a first optical member and a lens 53 with a concave shape as a second optical member 53, both illustrated in FIG. 3. The blade driver that drives each stop blade 103 along the curved path includes the driving ring 102 as the rotating member that rotates each stop blade 103, and the driver 105 connected to the outer circumferential edge portion of the driving ring 102. That is, the blade driver rotates the driver 105 to thereby rotate the driving ring 102. With the driving ring 102 rotated, each stop blade 103 is rotated. This configuration in which, at the time of the rotation of each stop blade 103, the driver 105 is, at the outer circumferential portion of the driving ring 102, connected to the end portion of the driving ring 102 in the optical axis direction (side opposite to an end portion side of the second fixed aperture 112) so as to transmit the rotational force is highly advantageous for miniaturizing the aperture stop apparatus 110 in the direction orthogonal to the optical axis direction. This configuration of the aperture stop apparatus 110 of this embodiment enables the miniaturization of the optical apparatus including the aperture stop apparatus 110 that drives each stop blade 103 between the two lenses to control quantity of light. In other words, the aperture stop apparatus 110 in this embodiment is capable of not only driving each stop blade 103 from the outer circumferential edge portion of the driving ring 102 to stably open and close each stop blade 103, but also of rotating each stop blade 103 of the light-quantity control apparatus in the smaller installation space. This makes it easy to form a desired light-passing aperture and is, moreover, highly advantageous for miniaturizing the light-quantity control apparatus.

Although this embodiment described the case where (the center axis of) the supporting hole portion 107 formed on the base plate 101 and (the center axis of) the boss portion 108 formed on the driving ring 102 are tilted with respect to the optical axis direction, the supporting hole portion 107 and the boss portion 108 may be formed to extend in parallel with the optical axis direction as long as each stop blade 103 (stop blade-supported portion 103b) is rotated with respect to a virtual axis tilted with respect to the optical axis direction.

It is noted that although this embodiment described the configuration in which the boss portion 103c formed on the stop blade-supported portion 103b of each stop blade 103 so as to allow the stop blade 103 to be rotated thereabout is inserted into the supporting hole portion 107 of the base plate 101, an alternative configuration may be employed in which a domical portion similar to the domical shape of the cover plate 104 is formed on the base plate 101 and thereon the boss portion inserted into the cam groove portion is formed and in which the driving ring 102 is rotatably disposed on an outer side of the fixed aperture of the domical portion and thereon the supporting boss portion is formed. In the case where the boss portion inserted into the cam groove portion is provided on the base plate 101, the supporting boss portion formed on the driving ring 102 may be inserted into the hole portion formed on each stop blade 103, and the boss portion formed on the base plate 101 may be inserted into the cam groove portion. In other words, although, in this embodiment, each stop blade 103 is rotated about the rotational axis at the base plate (101) side, each stop blade 103 may be rotated thereabout at a driving ring (102) side. As long as relative positions of the stop blade-supporting boss portion and the cam boss portion respectively inserted into the hole portion and the cam groove portion of each stop blade 103 are changeable, any one of the stop blade-supporting boss portion and the cam boss portion may be formed in the base plate 101 and the other thereof may be formed in the stop driving ring 102.

Although this embodiment described the case where the boss portions 103c formed on the stop blades 103 and the boss portions 108 formed in the driving ring 102 are respectively inserted into the supporting hole portions 107 formed in the base plate 101 and the cam groove portions 103d formed in the stop blades 103, a hole portion corresponding to the stop blade-supporting boss portion 107 and a boss portion corresponding to the boss portion 108 may be formed in each stop blade 3 to respectively insert the supporting boss portion formed in the base plate 101 into the hole portion of each stop blade 103 and the boss portion formed in each stop blade 103 into the cam groove portion formed in the driving ring 102.

In the aperture stop apparatus 110 with the above-described configuration, the intermediate portion 103e and the stop blade-supported portion 103b of each stop blade 103, which are described above, each have the tilt α in the optical axis direction. As a result, as illustrated in FIG. 3, a concave space S is formed that has, in the optical axis direction, a depth from the stop blade-supported portion (103b) side to a light-blocking portion (103a) side of each of the stop blades 103 inside the radial direction than each of the stop blades 103. An end portion of the concave space S at the stop blade-supported portion (103b) side is opened in the first fixed aperture 106 formed in the base plate 101. On the other hand, an end portion of the concave space S at the light-blocking portion (103a) side is closed in the second fixed aperture 112 formed in the driving ring 102 (and also in the stop aperture A and in the third fixed aperture 113 formed in the cover plate 104). In other words, the concave space S faces the first to third fixed apertures 106, 112 and 113, and is located in the curved path that is the space between the lens 51 with the convex shape and the lens 53 with the concave shape.

The concave space S can be referred to also as a space whose outer circumference is surrounded by a surface of each of the stop blades 103. However, in this embodiment, the surface of each of the stop blades 103 does not directly face the concave space S, which means that the domical wall portion 102a of the driving ring 102 surrounding the concave space S is located between the surface of each stop blade 103 and the concave space S. It is noted that the domical wall portion 102a is not necessarily required. As long as each stop blade 103 is stably guided by, for example, a rail radially extending in the radial direction, the surface of each stop blade 103 may directly face the concave space S without the domical wall portion 102a provided.

### Embodiment 2

The present invention relates to a light-quantity control apparatus and an optical apparatus having the light-quantity control apparatus. The light-quantity control apparatus is installed in an optical apparatus such as a digital camera, a video camera and an interchangeable lens.

An optical apparatus such as a camera is necessary to have compactness. In particular, when a lens barrel for holding an image taking lens protrudes from a camera body in its optical axis direction, it is necessary to reduce a length of the lens barrel in the optical axis direction as short as possible. Japanese Patent Laid-Open No. 2004-184486 discloses a light-quantity control apparatus in which a plurality of stop blades for controlling a quantity of light by controlling a size of a light-passing aperture (stop aperture) and a driving ring for opening/closing the stop blades are arranged between a base plate and a partition plate, and in which a shutter blade for opening/closing the light-passing aperture (shutter aperture) is arranged between the partition plate and a cover plate. In this manner, a light-quantity control apparatus having an aperture stop function and a shutter function is implemented using a single base plate. Therefore, a camera can be miniaturized in an optical axis direction, compared to a case where the aperture stop apparatus and the shutter apparatus are separately provided.

In the light-quantity control apparatus disclosed in Japanese Patent Laid-Open No. 2004-184486, it is also necessary to provide a thickness of the base plate in the optical axis direction, a space for moving the stop blade, and a space for moving the shutter blade. Therefore, miniaturization is restricted.

This embodiment provides a light-quantity control blade of a light-quantity control apparatus including a stop blade and a shutter blade and enabling miniaturization in an optical axis direction while achieving downsizing in a radial direction, and also provides the optical apparatus using the light-quantity control blade.

A light-quantity control apparatus of this embodiment includes a base member; a stop blade including a stop portion to control quantity of light passing through a light-passing aperture and a supported portion rotatably supported with respect to the base member; and a shutter blade including a shutter portion to block light through the light-passing aperture and a supported portion rotatably supported with respect to the base member. When a direction orthogonal to an aperture plane of the light-passing aperture is defined as an optical axis direction and a direction orthogonal to the optical axis direction is defined as a radial direction, the supported portions have tilts toward the same side in the optical axis direction with respect to the aperture plane so as to locate the stop portion and the shutter portion distant from the respective supported portions of the stop blade and the shutter blade in the optical axis direction so that a concave space facing the light-passing aperture is formed more inside in the radial direction than the stop blade and the shutter blade.

The light-quantity control apparatus of this embodiment is mountable on an optical apparatus including an optical system in which the light-quantity control apparatus and a lens are disposed in the optical axis direction, and allowing at least a part of the lens to be inserted into the concave space in the light-quantity control apparatus.

According to this embodiment, it is possible to form the concave space, into which the lens can be inserted, in a radially inner area than the stop and shutter blades without opening the stop and shutter blades to their fully opened states in the light-quantity control apparatus including the stop and shutter blades. That is, it is possible to insert the lens inside in the optical axis direction while preventing a size increase of the light-quantity control apparatus in the radial direction. Therefore, downsizing of the optical apparatus on which the light-quantity control apparatus is mounted can be achieved.

The supported portions of the stop blade and the shutter blade are supported rotatably about an axis tilted with respect to the optical axis direction so that these blades can be rotated more smoothly.

Embodiment 2 will hereinafter be described with reference to the accompanying drawings.

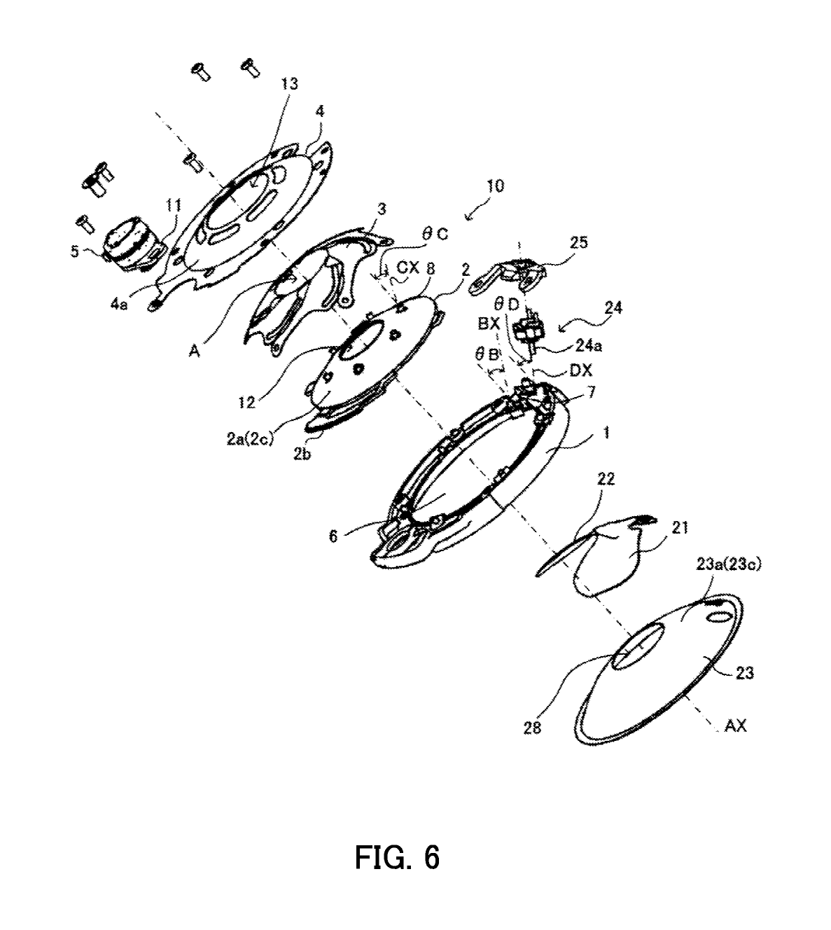

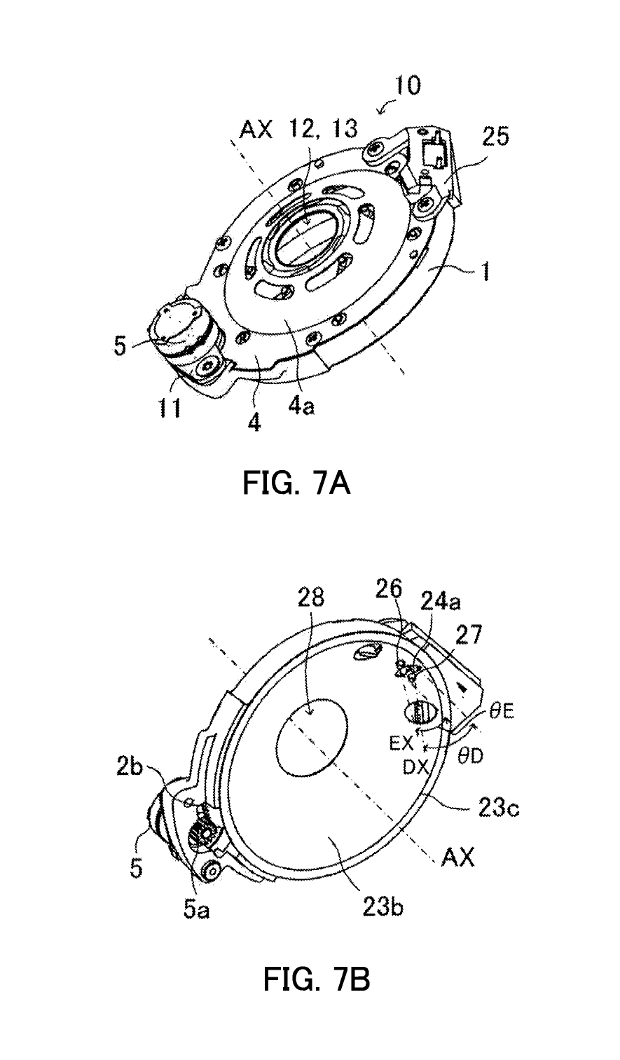

FIGS. 6, 7A and 7B illustrate an iris type aperture stop/shutter apparatus 10 as a light-quantity control apparatus that is Embodiment 2 of the present invention. In these drawings, a base plate 1 as a base member formed in a ring shape has an opening 6 formed in an inner circumferential part thereof. In the following description, an axis passing through a center of the aperture stop/shutter apparatus 10 and orthogonal to an opening plane of the opening 6 formed in the base plate 1 and an aperture plane of each fixed aperture described below is referred to as “an optical axis AX,” and a direction where the optical axis AX extends is referred to as “an optical axis direction.” In addition, a direction orthogonal to the optical axis direction is referred to as “a radial direction.”

A stop blade-supporting boss portion (protruding portion) 7 as a stop blade-supporting portion is formed at each of a plurality of circumferential places of a ring portion surrounding the opening 6 of the base plate 1. A center axis BX of each stop blade-supporting boss portion 7 has a tilt angle θB with respect to the optical axis direction (optical axis AX).

A stop driving ring 2 serves as a driving member. The stop driving ring 2 has a domical wall portion 2a formed in a domical shape concave toward the base plate 1 (opening 6) (in other words, convex toward an opposite side to the base plate 1). A first fixed aperture 12 as a light-passing aperture is formed in an innermost circumferential portion (diametric center portion) of the domical wall portion 2a. In addition, a driven gear 2b is formed in a circumferential part of an outer circumferential side portion of the aperture-stop driving ring 2 than the domical wall portion 2a. In the domical wall portion 2a, a concave surface on a base plate (1) side and a convex surface (hereinafter, referred to as “a stop guide surface”) 2c on an opposite side thereto are respectively formed in a curved surface shape (for example, a spherical surface shape). A position of the aperture plane of the first fixed aperture 12 in the optical axis direction is distant from the base plate 1 (that is, the opening plane of the opening 6) as compared to an outer circumferential edge of the domical wall portion 2a of the aperture-stop driving ring 2. That is, in the aperture-stop driving ring 2, the domical wall portion 2a is formed so as to protrude in a direction distant from the base plate 1 in the optical axis direction.

In addition, a cam boss portion 8 is formed at each of a plurality of circumferential places of the stop guide surface 2c (circumferential places around the first fixed aperture 12) of the domical wall portion 2a. A center axis CX of each cam boss portion 8 has a tilt angle θC with respect to the optical axis direction (optical axis AX) extending in a direction normal to the stop guide surface 2c.

Reference numeral 3 denotes a stop blade serving as a light-blocking blade. In this embodiment, a plurality of the stop blades 3, specifically six stop blades 3, are provided. Each stop blade 3 is a thin plate member having a light-blocking property for forming, radially inside the first fixed aperture 12 formed in the stop driving ring 2, a stop aperture A whose circumference is a light-blocking area.

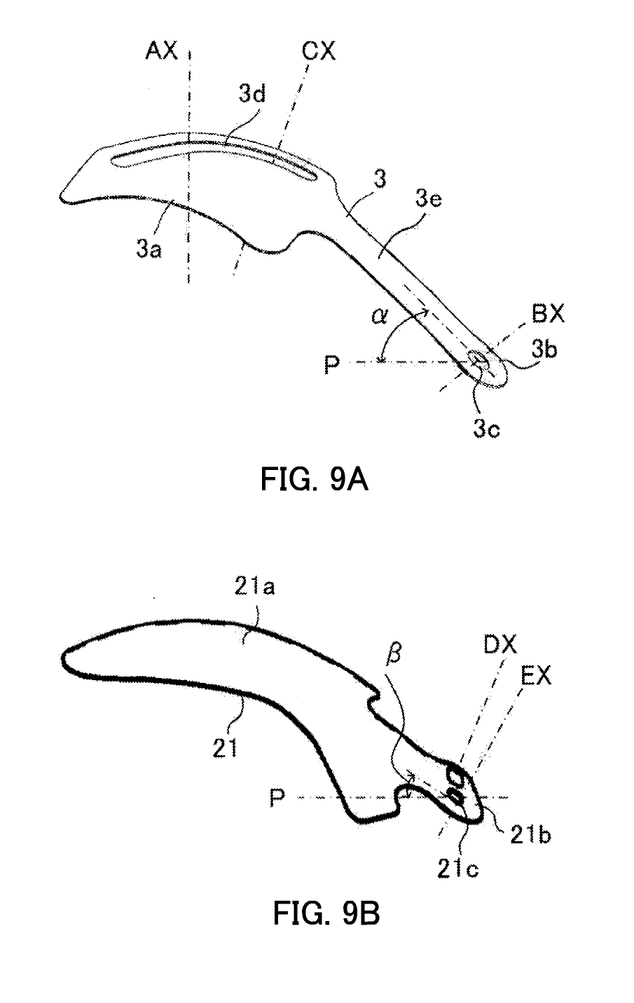

As illustrated in FIG. 9A in detail, each stop blade 3 includes a stop portion 3a as a light-blocking portion for forming a stop aperture A and a stop blade-supported portion 3b having a hole portion 3c into which the stop blade-supporting boss portion 7 of the base plate 1 is inserted. The stop blade-supported portion 3b (that is, the stop blade 3) is supported with respect to the base plate 1, by insertion of the stop blade-supporting boss portion 7 into the hole portion 3c, rotatably about the stop blade-supporting boss portion 7. In addition, the stop blade 3 has an intermediate portion 3e that connects the stop portion 3a and the stop blade-supported portion 3b.

Each stop blade 3 is disposed so as to face (or extend along) the stop guide surface 2c of the domical wall portion 2a of the stop driving ring 2. The stop portion 3a is formed in a spherical surface shape (a curved surface shape) having a curvature substantially the same as that of the stop guide surface 2c of the domical wall portion 2a. For this reason, when the stop blade 3 is rotated, the stop portion 3a is rotated in a direction to advance and retract into and from an radially inside area of the first fixing aperture 12 (area facing the first fixed aperture 12), that is, a direction to change a size of the stop aperture A while the stop portion 3a is rotated along the stop guide surface 2c, in other words, by being guided by the stop guide surface 2c. The above advancing/retracting direction is hereinafter referred to as “a stop opening/closing direction.”

The intermediate portion 3e and the stop blade-supported portion 3b of each stop blade 3, that is, at least a stop blade-supported portion (3b) side part than the stop portion 3a has a tilt α toward the optical axis direction with respect to the aperture plane (indicated as “P” in FIG. 9A) of the opening 6 of the base plate 1. This tilt α corresponds to a tilt with respect to the aperture plane of the first fixed aperture 12 formed in the stop driving ring 2 and to a tilt with respect to the aperture plane of a second fixed aperture formed in a stop cover plate described below. Furthermore, since each aperture plane is formed along the radial direction, the tilt α can also be referred to as a tilt with respect to the radial direction.

The tilt α is set to be equal to or lower than 90°. Giving the tilt α to the intermediate portion 3e and the stop blade-supported portion 3b causes the stop portion 3a to be located distant from the stop blade-supported portion 3b in the optical axis direction. In addition, a center axis of the hole portion 3c formed in the stop blade-supported portion 3b has a tilt with respect to the optical axis AX so as to match the center axis BX of the stop blade-supporting boss portion 7. Therefore, the stop blade 3 can smoothly rotate, compared to a case where the center axis of the stop blade-supporting boss portion 7 extends in the optical axis direction.

It is noted that, in each stop blade 3, the tilt of the stop blade-supported portion 3b toward the optical axis direction with respect to the aperture plane (radial direction) P is larger than that of the stop portion 3a. In other words, the tilt of the stop portion 3a toward the optical axis direction with respect to the aperture plane P is smaller than that of the stop blade-supported portion 3b. In addition, the entire stop blade 3 from the stop blade-supported portion 3b to the stop portion 3a may be formed in a spherical surface shape (a curved surface shape).

Furthermore, each stop blade 3 has a cam groove portion 3d into which the cam boss portion 8 formed in the stop driving ring 2 is inserted and with which the cam boss portion 8 is engaged. As described above, the center axis CX of the cam boss portion 8 extends in the direction normal to the stop guide surface 2c. For this reason, compared to a case where the center axis of the cam boss portion 8 extends in the optical axis direction, the cam boss portion 8 can smoothly move in the cam groove portion 3d, and the stop portion 3a (i.e., the stop blade 3) can be rotated in the stop opening/closing direction with good position accuracy. It is noted that the stop portion 3a is formed in a spherical surface shape and the stop guide surface 2c may be formed in a truncated conical surface shape instead of the curved surface shape.

In FIGS. 6 and 7A, a stop cover plate (stop cover member) 4 is disposed on an opposite side to the base plate 1 with respect to the stop driving ring 2 and the stop blades 3 to form a stop blade room for housing the stop blades 3 between the stop cover plate 4 and the stop driving ring 2 (domical wall portion 2a). The stop cover plate 4 includes a domical wall portion 4a having a domical shape concave toward the base plate side (opening 6 side), in other words, convex toward the opposite side to the base plate 1, and a ring portion formed in an outer circumferential portion of the domical wall portion 4a. The domical wall portion 4a is formed in a spherical surface shape or a curved surface shape having approximately the same curvature as that of the domical wall portion 2a of the stop driving ring 2.

A second fixed aperture 13 as a light-passing aperture is formed in an innermost circumferential portion (diametric center portion) of the domical wall portion 4a. An aperture plane of the second fixed aperture 13 is located distant from the base plate 1 (opening 6) in the optical axis direction relative to an outer circumferential edge of the domical wall portion 4a. That is, in the stop cover plate 4, the domical wall portion 4a is formed so as to protrude in a direction distant from the base plate 1 in the optical axis direction.

The ring portion of the stop cover plate 4 is coupled with the base plate 1 using screws, and thereby the stop cover plate 4 is integrated with the base plate 1. For this reason, similar to the base plate 1, the stop cover plate 4 may also serve as a base member.

It is noted that the stop cover plate 4 may be omitted by forming a domical wall portion similar to the domical wall portion 4a of the stop cover plate 4 in the base plate 1 and forming a fixed aperture in the domical wall portion of the base plate.

Reference numeral 5 denotes a stop driver including an actuator such as a stepping motor. A driving gear 5a meshing with the driven gear 2b of the stop driving ring 2 is fixed to an output shaft of the stepping motor as illustrated I FIG. 7B. The stop driver 5 is fixed (installed) to the base plate 1 via a motor base plate 11 and the stop cover plate 4. The stop driver 5 is disposed at one place in an outer circumferential portion of the base member including the base plate 1 and the stop cover plate 4 than the domical wall portion 4a. In other words, the stop driver 5 is disposed so as to protrude from its surrounding portions in a same direction as that where the domical wall portion 4a protrudes with respect to its surrounding portions.

In this manner, the domical wall portion 4a and the stop driver 5 have the same protruding direction from the base member. Thereby, as in a case where the aperture stop/shutter apparatus 10 is mounted on an optical apparatus such as a camera as described in Embodiment 4 below, it is possible to effectively use a space inside the optical apparatus (particularly, a space on an opposite side to that where the domical wall portion 4a and the stop driver 5 are arranged), which enables miniaturizing the optical apparatus.

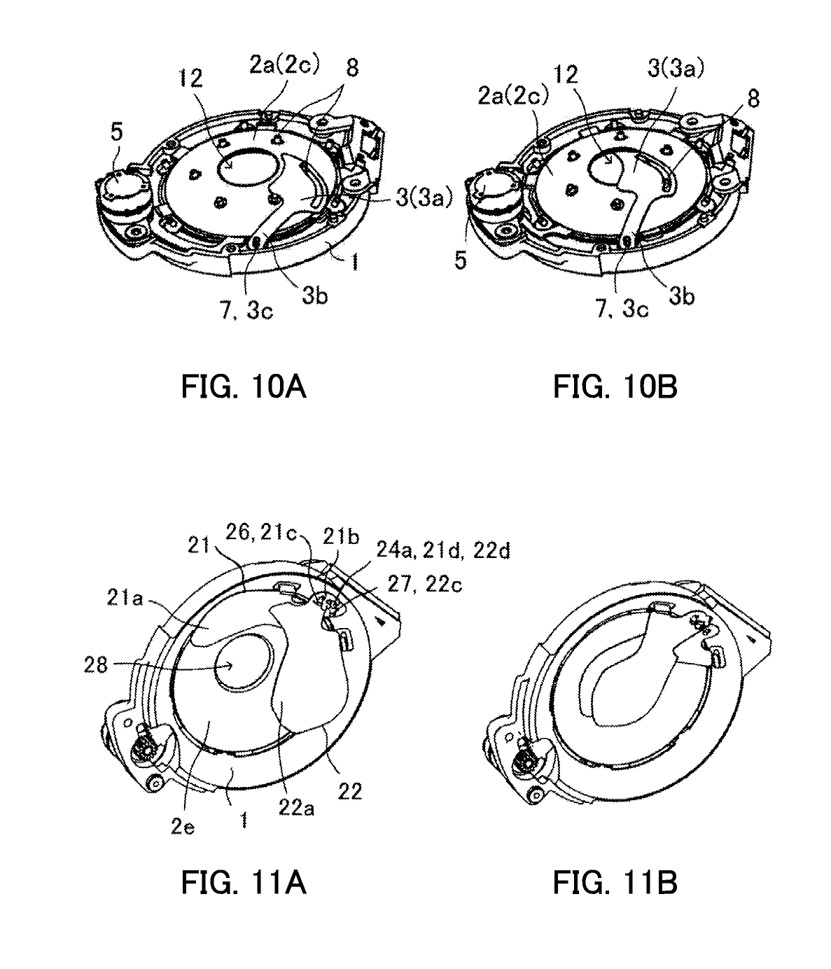

When the stop driver 5 is energized and thereby the driving gear 5a is rotated, as illustrated in FIGS. 10A and 10B, a rotational force from the stop driver 5 is transmitted to the stop driving ring 2 through the driving gear 5a and the driven gear 2b and rotates the stop driving ring 2 about the optical axis AX (around the light-passing aperture) with respect to the base plate 1. With the rotation of the stop driving ring 2, the cam boss portion 8 provided in the stop driving ring 2 moves in the cam groove portion 3d formed in the stop portion 3a of each stop blade 3. Therefore, each stop blade 3 is rotated in the stop opening/closing direction about the stop blade-supporting boss portion 7 inserted into the hole portion 3c of the stop blade-supported portion 3b. In this manner, the rotation of the stop portions 3a of the stop blades 3 (only one stop blade 3 is illustrated in FIGS. 10A and 10B) in the stop opening/closing direction changes a diameter of the stop aperture A formed by the stop portions 3a, which increases and decreases (controls) a quantity of light passing through the stop aperture A.

It is noted that, although this embodiment described the case where (the center axis of) the stop blade-supporting boss portion 7 formed in the base plate 1 and (the center axis of) the cam boss portion 8 formed in the stop driving ring 2 are tilted with respect to the optical axis direction, the stop blade-supporting boss portion 7 and the cam boss portion 8 may be formed to extend in parallel with the optical axis direction as long as the stop blade 3 (stop blade-supported portion 3b) is rotated with respect to a virtual axis tilted with respect to the optical axis direction.

Moreover, a domical wall portion similar to the domical wall portion 4a of the stop cover plate 4 may be formed in the base plate 1, and a fixed aperture may be formed in the domical wall portion. In addition, a cam boss portion may be formed in an inner surface (concave surface) of the domical wall portion, and a stop blade-supporting boss portion may be formed in the rotatable stop driving ring 2. In this case, the stop blade-supporting boss portion formed in the stop driving ring 2 is inserted into the hole portion 3c formed in the stop blade 3, and the cam boss portion formed in the domical wall portion of the base plate 1 is inserted into the cam groove portion 3d. Also in such a configuration, rotating the stop driving ring 2 can rotate the stop blade 3 in the stop opening/closing direction. In this manner, as long as relative positions of the stop blade-supporting boss portion and the cam boss portion respectively inserted into the hole portion 3c and the cam groove portion 3d of the stop blade 3 are changeable, any one of the stop blade-supporting boss portion and the cam boss portion may be formed in the base plate 1 and the other thereof may be formed in the stop driving ring 2. Even when the stop driving ring 2 directly supports the stop blade-supported portion 3b of the stop blade 3 in this manner, it is common that the stop blade-supported portion 3b is rotatably supported with respect to the base plate 1.

Although this embodiment described the case where the stop blade-supporting boss portion 7 formed in the base plate 1 and the cam boss portion 8 formed in the stop driving ring 2 are respectively inserted into the hole portion 3c and the cam groove portion 3d formed in the stop blade 3, a boss portion corresponding to the stop blade-supporting boss portion and a boss portion corresponding to the cam boss portion 8 may be formed in the stop blade 3 to insert them into a hole portion formed in the base plate 1 and a cam groove portion formed in the stop driving ring 2.

Furthermore, in FIG. 6, reference numerals 21 and 22 denote two shutter blades 21 and 22, which are disposed on an opposite side to the stop blades 3 with respect to the base plate 1 (and the stop driving ring 2). Similar to the stop blade 3, the shutter blade 21 and the shutter blade 22 are each formed as a thin flat plate member having a light-blocking property.

Reference numeral 23 denotes a shutter cover plate (shutter cover member), which is disposed on an opposite side to the base plate 1 and the stop driving ring 2 with respect to the shutter blades 21 and 22. The shutter cover plate 23 is fixed to the base plate 1 to form a shutter blade room for housing the shutter blades 21 and 22 between the shutter cover plate 23 and the stop driving ring 2 (domical wall portion 2a). The shutter cover plate 23 includes a domical wall portion 23a having a domical shape convex toward the base plate 1 side (opening 6 side), in other words, concave toward the opposite side to the base plate 1, and a ring portion formed in an outer circumferential portion of the domical wall portion 23a. The domical wall portion 23a is formed in a spherical surface shape (a curved surface shape) having approximately the same curvature as that of the domical wall portion 2a of the stop driving ring 2.

A third fixed aperture 28 as a light-passing aperture is formed in an innermost circumferential portion (diametric center portion) of the domical wall portion 23a. In the optical axis direction, the aperture plane of the third fixed aperture 28 is located distant from the base plate 1 (opening 6) relative to an outer circumferential edge portion (ring portion) of the domical wall portion 23a. That is, in the shutter cover plate 23, the domical wall portion 23a is formed so as to protrude in a direction distant from the base plate 1 in the optical axis direction.

The shutter cover plate 23 is integrated with the base plate 1 by bonding the ring portion of the shutter cover plate 23 to the base plate 1. Thus, similar to the base plate 1 and the stop cover plate 4, the shutter cover plate 23 can be treated as a base member.

As illustrated in FIG. 9B in detail, the shutter blade 21 includes shutter portion 21a as a light-blocking portion and a shutter blade-supported portion 21b. The shutter portion 21a advances and retracts into and from an area facing the third fixed aperture 28 of the shutter cover plate 23 to open and close the third fixed aperture 28. Closing the third fixed aperture 28 blocks the light passing through the third fixed aperture 28 (and the first and second apertures 12 and 13).

A hole portion 21c is formed in the shutter blade-supported portion 21b, and a shutter blade-supporting boss portion 26 formed in the base plate 1 is inserted into the hole portion 21c. As a result, the shutter blade-supported portion 21b (i.e., shutter blade 21) is supported with respect to the base plate 1 rotatably about the shutter blade-supporting boss portion 26. In addition, a hole portion 21d into which a shutter driving pin described below is inserted and which engages therewith is formed in the shutter blade 21.

The other shutter blade 22 is formed similarly to the shutter blade 21. As illustrated in FIGS. 11A and 11B, the shutter blade 22 includes a shutter portion 22a, a shutter blade-supported portion 22b having a hole portion 22c into which the supporting boss portion is inserted, and a hole portion 22d into which the shutter driving pin is inserted. In FIGS. 11A and 11B, the shutter blades 21 and 22 are illustrated in a state of removing the shutter cover plate 23.

The shutter blades 21 and 22 are disposed to face (or extend along) a concave surface 2e of the domical wall portion 2a of the stop driving ring 2 and a convex surface 23c of the domical wall portion 23a of the shutter cover plate 23. The shutter blades 21 and are each formed in a curved surface shape (for example, a spherical surface shape) having approximately the same curvature as those of the concave surface 2e and the convex surface 23c. Therefore, when the shutter blades 21 and 22 are rotated, the shutter portions 21a and 22a are rotated in a direction to open or close the third fixed aperture 28 (the direction is hereinafter referred to as “a shutter opening/closing direction”) along the concave surface 2e of the domical wall portion 2a of the stop driving ring 2 and the convex surface 23c of the domical wall portion 23a of the shutter cover plate 23 while the shutter portions 21a and 22a are guided by the concave surface 2e and the convex surface 23c. The concave surface 2e and the convex surface 23c are hereinafter collectively referred to as “a shutter guide surface.”

A portion of the shutter blades 21 and 22 closer to the supported portions 21b and 22b than the shutter portions 21a and 22a has a tilt β toward the optical axis direction with respect to the aperture plane P described above. This tilt β is set to be equal to or smaller than 90°. Giving the tilt β to the shutter blade-supported portions 21b and 22b causes the shutter portions 21a and 22a to be located distant from the shutter blade-supported portions 21b and 22b in the optical axis direction. It is noted that, in the shutter blades 21 and 22, the tilt β of the shutter blade-supported portions 21b and 22b toward the optical axis direction with respect to the aperture plane P is larger than that of the shutter portions 21a and 22a with respect to the aperture plane P. In other words, the tilt of the shutter portions 21a and 22a toward the optical axis direction with respect to the aperture plane P is smaller than that of the shutter blade-supported portions 21b and 22b.

Reference numeral 24 denotes a shutter driver 24 which rotates the shutter blades 21 and 22 in the shutter opening/closing direction. Reference numeral 25 denotes a fixing member 25 which fixes the shutter driver 24 to the base plate 1. The shutter driver 24 includes a positively magnetized magnet, a stator yoke wound around the magnet, a coil for exciting the stator yoke and others. The shutter driver 24 reciprocatingly rotates the magnet between two positions by energization of the coil.

In this embodiment, the shutter driver 24 and the fixing member 25 are installed to a surface of the base plate 1 on an opposite side to that where the shutter blade-supporting boss portions 26 and 27 that support the shutter blade-supported portions 21b and 22b of the shutter blades 21 and 22 are provided (a same side surface to which the stop driver 5 is fixed).

A shutter driving pin 24a is integrally formed in the magnet of the shutter driver 24. The shutter driving pin 24a penetrates through a hole portion formed in the base plate 1 and is inserted into driving hole portions 21d and 22d of the shutter blades 21 and 22 to engage therewith. Therefore, when the shutter driving pin 24a is rotated by energization of the coil, the shutter blades 21 and 22 are rotated in the shutter opening/closing direction about the shutter blade-supporting boss portions 26 and 27 as illustrated in FIGS. 11A and 11B.

The shutter blades 21 and 22 (at least the shutter portions 21a and 22b) are each formed in a spherical surface shape (curved surface shape) having a curvature approximately the same as that of the guide surfaces 2e and 23c of the domical wall portion 2a of the stop driving ring 2 and the domical wall portion 23a of the shutter cover plate 23. For this reason, the shutter blades 21 and 22 are rotated in the shutter opening/closing direction along the guide surfaces 2e and 23c while the shutter blades 21 and 22 are guided by the guide surfaces 2e and 23c.

As illustrated in FIGS. 6 and 9B, a center axis DX of the shutter driving pin 24a has a tilt θD extending in a direction normal to the domical wall portion 23a (guide surface 2e) with respect to the optical axis direction (optical axis AX). In addition, center axes of the driving hole portions 21d and 22d engaging with the shutter driving pin 24a in the shutter blades 21 and 22 each have a tilt with respect to the optical axis AX so as to match the center axis DX of the shutter driving pin 24a. In addition, as illustrated in FIG. 7B, the shutter blade-supporting boss portions 26 and 27 each have a tilt θE with respect to the optical axis direction (optical axis AX), and, as illustrated in FIG. 9B, center axes of the hole portions 21c and 22c engaging with the shutter blade-supporting boss portions 26 and 27 each have a tilt with respect to the optical axis AX so as to match center axes EX of the shutter blade-supporting boss portions 26 and 27. Therefore, it is possible to more smoothly and rapidly rotate the shutter blades 21 and 22 to perform a shutter operation, compared to a case where the center axes of the shutter driving pin 24a and the shutter blade-supporting boss portions 26 and 27 extend in the optical axis direction.

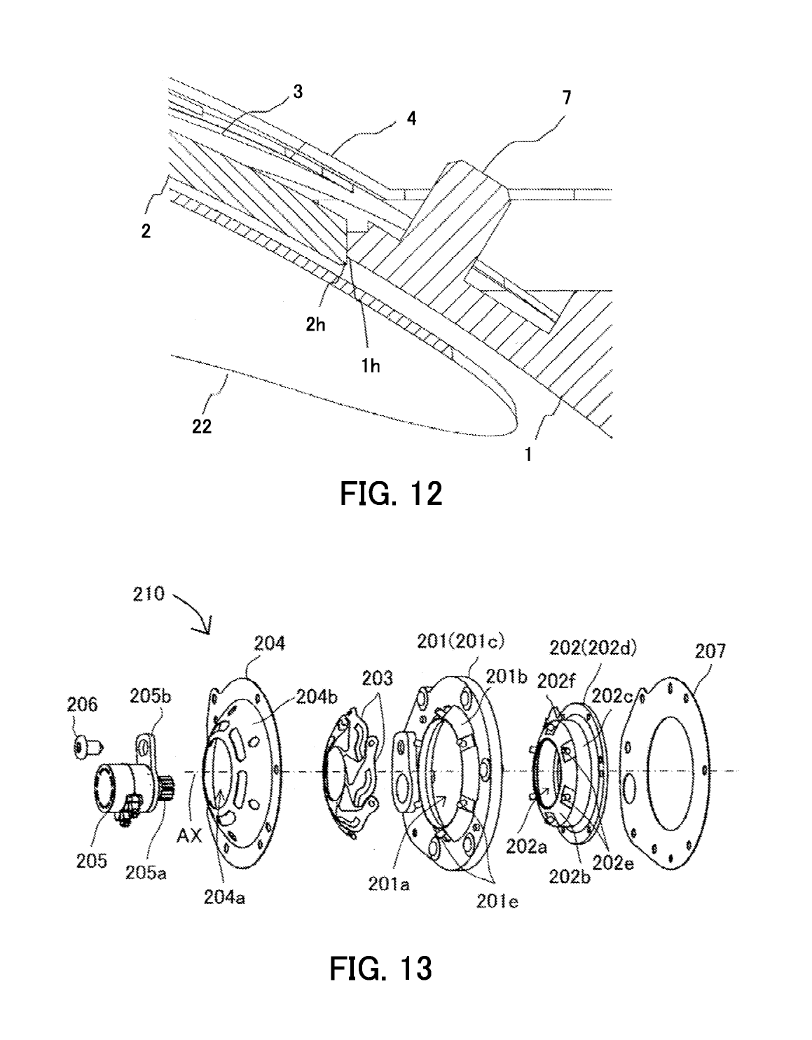

As in the configuration applied to the stop blade 103 in Embodiment 1, an outer circumferential portion that drives the shutter blades 21 and 22 in this embodiment can be provided with a step to prevent the shutter blades 21 and 22 from being caught. FIG. 12 illustrates an enlarged view of the outer circumferential side portion provided with the step as a variation of the aperture stop/shutter apparatus 10 described in this embodiment. In order to have the step between the base plate 1 and an outer circumferential side portion of the driving ring 2, a step portion 1h is provided on an inner circumferential side end portion of the base plate 1, and a step portion 2h is provided on an outer circumferential side end portion of the driving ring 2. The driving ring 2 is arranged on the step portion 1h of the base plate 1 such that the shutter blades 21 and 22 are prevented from touching. The step portions 1h and 2h are shaped smaller toward an outside in a direction along movement of the shutter blades 21 and 22 such that a curvature of the driving ring 2 is smaller than a curvature of the base plate 1. This prevents the shutter blade 22 from being caught at the outer circumferential portion, thereby achieving smooth movement.

This embodiment described the configuration that enables the light-quantity control apparatus on which the stop blade and the shutter blades are mounted to be downsized in the radial direction so as to achieve smooth movement. This embodiment may have the configuration of the stop blade 103 described in Embodiment 1 so as to form portions of the shutter blades 21 and 22 such that they have different thicknesses with thicker portions closer to the supported portions, which is a center of rotation. The thicker portions, which are thicker than the light-quantity controller and provided to other than the light-quantity controller, enable the shutter blades 21 and 22 as the light-quantity control blades to have improved strength. This enables an accurate operation of the shutter blades 21 and 22. Similarly to the stop blade, the light-quantity controller is formed in a spherical surface shape, and the guide surfaces for the shutter blades may be formed in a truncated conical surface shape instead of a spherical surface shape.

The light-quantity control blades are arranged so as to move in a space formed between any pair of the stop cover member 4, the driving ring 2 and the shutter cover plate 23 that each have a convex shape toward an identical direction. This arrangement facilitates movement of the light-quantity control blades that are contributive to downsizing.

It is noted that, although this embodiment described the case where the shutter blade-supporting boss portions 26 and 27 formed in the base plate 1 are inserted into the hole portions 21c and 22c formed in the shutter blades 21 and 22, a shutter blade-supporting boss portion may be installed in the shutter cover plate 4. In addition, boss portions corresponding to the shutter blade-supporting boss portions 26 and 27 may be formed in the shutter blades 21 and 22 to insert them into the hole portion formed in the base plate 1.

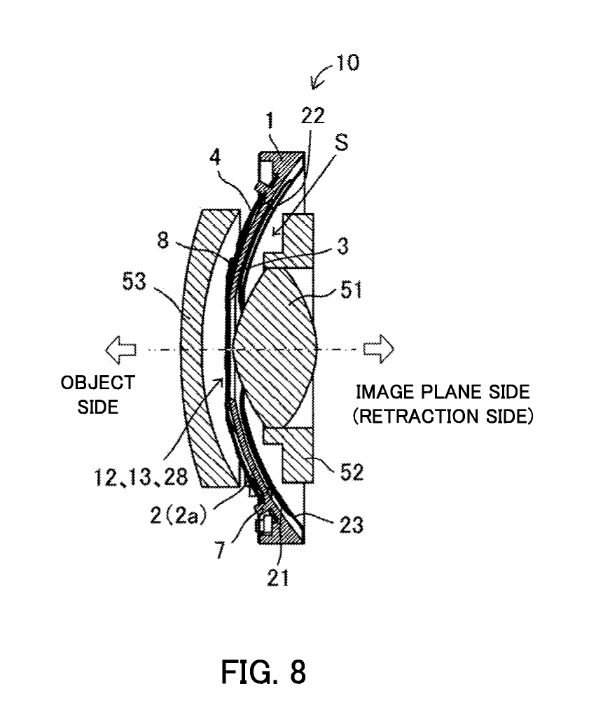

As described above, in the aperture stop/shutter apparatus 10 of this embodiment, the stop and shutter blade-supported portions 3b, 21b and 22b of the stop and shutter blades 3, 21 and 22 have tilts α and β toward the same one side in the optical axis direction with respect to the aperture plane P such that the stop and shutter portions 3a, 21a and 22a are located distant from the stop- and shutter blade-supported portions 3b, 21b and 22b in the optical axis direction, as illustrated in FIG. 3. In addition, the stop the driving ring 2 and the shutter cover plate 23 each have a shape (domical wall portions 2a and 23a) concave toward the one side. As a result, a concave space S facing the first to third fixed apertures (light-passing apertures) 12, 13 and 28 is formed inside in the radial direction than the stop blades 3, the stop the driving ring 2, the shutter cover plate 23 and the shutter blades 21 and 22 as illustrated in FIG. 8.

In practice, this concave space S is formed in a radially inside of the shutter cover plate 23 having the third fixed aperture 28 as a space having a depth in the optical axis direction toward the first and second fixed apertures 12 and 13 formed in the stop the driving ring 2 and the stop cover plate 4. The concave space S on its fixed aperture (12, 13, 28) side opens toward the first to third fixed apertures 12, 13 and 28 (that is, faces the first to third fixed apertures 12, 13 and 28), and the concave space S on an opposite side thereto opens toward an outside of the aperture stop/shutter apparatus 10 in the optical axis direction with its inner diameter increasing toward the opposite side.

As illustrated in FIG. 8, at least part of the lens 51 can be inserted into the concave space S. That is, according to this embodiment, it is possible to form the concave space S, into which at least part of the lens 51 can be inserted, in a radially inner area than the stop and shutter blades 3, 21 and 22 without opening the stop and shutter blades 21 and 22 up to their fully opened state.

In this embodiment, one of the stop blades 3 and the shutter blades 21 and 22 (the stop blades 3 in this embodiment) is disposed on an opposite side to the concave space S in the optical axis direction relative to the other one (the shutter blades 21 and 22 in this embodiment), and the stop blades 3 are disposed so as to be convex from the base plate 1 toward the opposite side to the concave space S. Such disposition of the stop blades 3 makes it possible to arrange convex surfaces of the stop blades 3 (the domical wall portion 4a of the stop cover plate 4) and a concave surface of a lens 53, which is disposed on an opposite side to the lens 51 with respect to the aperture stop/shutter apparatus 10, to be close to each other, as illustrated in FIG. 8. Thereby, it is possible to arrange the stop blades 3 and the shutter blades 21 and 22 in a narrow space between a convex surface of the lens 51 and the concave surface of the lens 53.

Furthermore, in this embodiment, the shutter blades 21 and 22, the base plate 1, and the stop blades 3 are arranged in this order in a concave direction of the concave space S (depth direction toward the first to third fixed apertures 12, 13, and 28). In other words, the stop blades 3 are disposed on a convex side where the aperture stop/shutter apparatus 10 is convex toward the optical axis direction, and the shutter blades 21 and 22 are disposed on a concave side where the aperture stop/shutter apparatus 10 is concave. The reason of that is as follows. Since the number of the stop blades 3 (six in this embodiment) is greater than the number of the shutter blades 21 and 22 (two in this embodiment), the number of the stop blade-supporting boss portions 7 formed in the base plate 1 and the number of the cam boss portions 8 formed in the stop the driving ring 2 increase accordingly. When such boss portions are formed in the wall portion having a domical shape, they are easily formed on its convex surface than a case where they are formed on its concave surface because a mold structure is simplified, which can improve productivity.

However, in comparison, the shutter blades, the base plate, and the stop blades may be arranged in this order in an opposite direction to the concave direction of the concave space, that is, the stop blades may be disposed on the concave side where the aperture stop/shutter apparatus 10 is concave toward the optical axis direction, and the shutter blades 21 and 22 are disposed on the convex side.

### Embodiment 3

An optical apparatus such as a camera is necessary to have compactness. In particular, when a lens barrel for holding an image capturing lens protrudes from a camera body in its optical axis direction, it is necessary to reduce a length of the lens barrel in the optical axis direction as short as possible.

Japanese Patent Laid-Open No. 2008-203576 discloses a light-quantity control apparatus that includes a base portion thicker than a blade portion and in which the blade portion and the base portion overlap with each other during a fully opened state, for the purpose of miniaturization. In the light-quantity control apparatus, the blade portion and the base portion thicker than the blade portion overlap with each other in an optical axis direction, which reduces a drive load of the light-quantity control apparatus.

However, the light-quantity control apparatus disclosed in Japanese Patent Laid-Open No. 2008-203576 requires providing a light-quantity control blade on a cam member and, moreover, a rotating member on the light-quantity control blade for driving the light-quantity control blade.

For this reason, the following light-quantity control apparatuses are required.

(1) A light-quantity control apparatus including a base member provided with an aperture portion; a light-quantity control blade that is mounted, from one surface side of the base member, on a blade supporting portion located at an outer circumferential edge portion of the aperture portion and that is rotatably provided in a circumferential direction; and a blade driving member engaged with the light-quantity control blade from the other surface side of the base member and configured to drive the light-quantity control blade. A blade engaging portion between the light-quantity control blade and the blade driving member is disposed on a side of the aperture portion than the blade supporting portion.

(2) A light-quantity control apparatus including a base member provided with an aperture portion; a light-quantity control blade that includes a light-quantity control portion for forming a light-passing aperture to control quantity of light passing through the aperture portion and a supported portion rotatably supported by a blade supporting portion provided to the base member; a blade driving member that includes a blade engaging portion engaged with the light-quantity control blade, is rotatably supported by the base member in a circumferential direction of the light-passing aperture and rotates to rotate the light-quantity control blade through the blade engaging portion; and a driver configured to rotate the blade driving member. When a direction orthogonal to an aperture plane of the light-passing aperture is defined as an optical axis direction, the light-quantity control blade has a shape in which the light-quantity control portion is located distant from the supported portion on one side in the optical axis direction such that a concave space having a depth toward the light-passing aperture more inside in a direction orthogonal to the optical axis direction than the light-quantity control blade is formed, the base member and the blade driving member are disposed at a side of the concave space than the light-quantity control blade, and the blade driving member is fixed to the base member from, of the optical axis direction, a direction opposite to a direction in which the light-quantity control blade is fixed to the base member such that the blade engaging portion is disposed on a side of the aperture portion than the blade supporting portion of the base member.

The light-quantity control apparatuses described in (1) and (2) are capable of opening and closing the light-quantity control blade with a simplified structure. This contributes to miniaturization of the optical apparatus in which any one of them is installed.

Next, referring to FIGS. 13, 16 and 19, description will be made of an iris type aperture stop apparatus 210 as a light-quantity control apparatus that is Embodiment 3 of the present invention. In the drawings, reference numeral 201 denotes a base plate as a base member. At a diametric center portion of the base plate 201, a fixed aperture 201a is formed. In the following description, an axis that passes through a center of an aperture plane of the fixed aperture 201a (which is also an aperture plane of a stop aperture that is a light-passing aperture) and is orthogonal to the aperture plane is referred to as “an optical axis AX”, and a direction in which the optical axis AX extends is referred to as “an optical axis direction.” A direction orthogonal to the optical axis direction (a direction along the aperture plane of the stop aperture) is referred to as “a direction orthogonal to the optical axis direction” or “a radial direction.

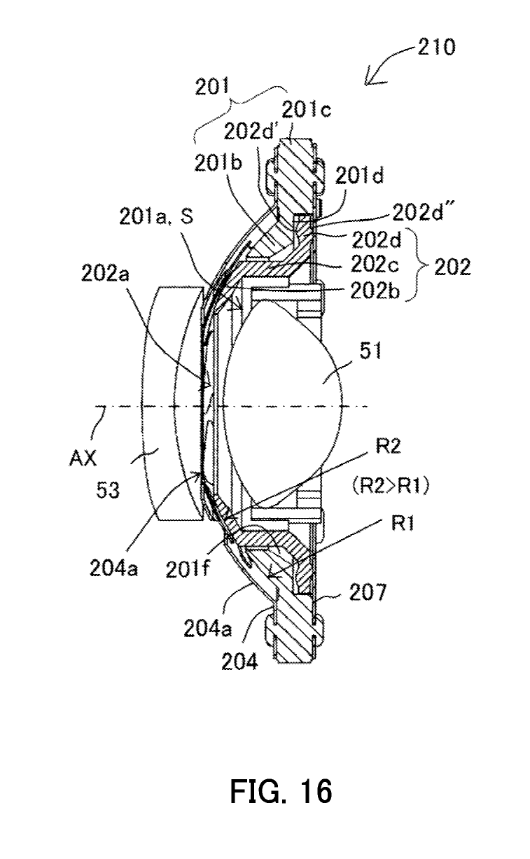

“In FIGS. 13 and 16, on a side more left than the base plate 201 (one side in the optical axis direction and one surface side of the base plate 201), a plurality of stop blades 203 each serving as a light-quantity control blade. In the following description, the left side in FIGS. 13 and 16, and a side corresponding thereto in other drawings are each referred to as “a front side.” On the other hand, in FIG. 13, on a side more right than each stop blade 203 and the base plate 201 (the other side in the optical axis direction and the other surface side of the base plate 1), a driving ring 202 as a blade driving member is illustrated. In the following description, the right side in FIGS. 13 and 16, and a side corresponding thereto in the other drawings are each referred to as “a rear side.”

As readily illustrated especially in a section of FIG. 16, in an outer circumferential portion of the base plate 201, a ring-shaped flange portion 201c to fix the aperture stop apparatus 210 to an inside of a lens barrel of a camera is formed. The flange portion 201c is formed as a wall portion extending from an inner side to an outer side in the direction orthogonal to the optical axis direction. In addition, more inside in the direction orthogonal to the optical axis direction than the flange portion 201c on the front side of the base plate 201 (one surface side) and around the fixed aperture (aperture portion) 201a, a blade guide portion 201b is formed so as to protrude toward the front side than the flange portion 201c. A further front end of an outer circumferential surface (front surface) of the blade guide portion 201b is formed as a curved surface (part of a spherical surface) located more inside in the direction orthogonal to the optical axis direction.

An inner circumferential surface of the blade guide portion 201b (which can be referred to also as an inner circumferential surface of the base plate 201) is formed as a cylindrical surface parallel to the optical axis direction. However, at each of a plurality of circumferential places of the cylindrical surface, a driving ring supporting convex portion 201f described later is formed. In addition, at each of a plurality of circumferential places of the outer circumferential surface of the blade guide portion 201b (a blade guide surface at a base member side), a supporting boss portion (protruding portion) 201e as a blade supporting portion having a convex shape. In the following description, the outer circumferential surface of the blade guide portion 201b is referred to as “a blade guide surface” of the base plate 201. As illustrated in FIG. 19, a center axis BX of each supporting boss portion 201e extends in a direction normal to the blade guide surface of the base plate 201 and has a tilt θ1 with respect to the optical axis direction (optical axis AX).

On an outer circumferential portion of the driving ring 202, a flange portion 202d to position the driving ring 202 with respect to the base plate 201 in the optical axis direction, in other words, to position the driving ring 202 in a direction of a surface different from the surface on which each supporting boss portion 201e is formed, that is, at a rear surface side (the other surface side) of the base plate 201 is formed. The flange portion 202d is formed as a wall portion extending from the inner side to the outer side in the direction orthogonal to the optical axis direction. A front surface of the flange portion 202d abuts against a driving ring positioning surface 201d formed on an inner circumferential portion of the flange portion 201c of the base plate 201 by one step deeper than a rear end surface of the flange portion 201c. It is noted that, on the front surface of the flange portion 202d of the driving ring 202, a protruding portion 202d′ is formed to reduce a rotational resistance of the driving ring 202 caused by the abutment against the driving ring positioning surface 201d of the base plate 201. On the other hand, on a rear surface of the flange portion 202d of the driving ring 202, a protruding portion 202d″ is formed to reduce the rotational resistance of the driving ring 202 caused by the abutment against a rear cover plate 207 described later.

In addition, more inside than the flange portion 202d of the driving ring 202 in the direction orthogonal to the optical axis direction, a cylindrical portion 202c extending from the flange portion 202d toward the front side (optical axis direction). Furthermore, a blade guide portion 202b is formed on the front side of the cylindrical portion 202c, and a fixed aperture 202a forming a fully opened aperture is formed on an inner circumferential portion of a front end of the blade guide portion 202b. In the optical axis direction, the aperture plane of the fixed aperture 202a is located on the front side than the fixed aperture (aperture portion) 201a of the base plate 201. An aperture diameter of the fixed aperture 202a is smaller than that of the fixed aperture 201a. The stop aperture (light-passing aperture) formed by each stop blade 203 is adjusted within an aperture diameter smaller than that of the fixed aperture 202a.

A further front end of an outer circumferential surface (front surface) of the blade guide portion 202b than a boundary between the outer circumferential surface and that of the cylindrical portion 202c as a rear end is formed as the curved surface (part of a spherical surface) located more inside in the direction orthogonal to the optical axis direction. On the other hand, a portion of the inner circumferential surface of the blade guide portion 202b close to the cylindrical portion 202c is formed as a curved surface similar to the outer circumferential surface of the blade guide portion 202b, and a portion of the inner circumferential surface of the blade guide portion 202b close to the fixed aperture 202a is formed as a plane tilted so as to make a thickness of the blade guide portion 202b become thinner as being closer to the fixed aperture 202a.

In this manner, the blade guide portion 202b of the driving ring 202 is formed so as to have a domical shape convex toward the front side. Inside the cylindrical portion 202c and the blade guide portion 202b in the direction orthogonal to the optical axis direction, a concave space S is formed that is opened at the rear end of the driving ring 202 and is concave so as to have a depth toward one side continuing up to the inner circumferential surface of the blade guide portion 202b in the optical axis direction. A front end of the concave space S faces the fixed aperture 202a (that is, the concave space S is opened in the fixed aperture 202a).

In addition, at each of a plurality of circumferential places of the outer circumferential surface of the blade guide portion 202b (the blade guide surface at a driving ring (202) side), a boss portion (protruding portion) 202e as the blade engaging portion having the convex shape is formed. In the following description, the outer circumferential surface of the blade guide portion 202b is referred to as “a blade guide surface” of the driving ring 202. As illustrated in FIGS. 16 and 19, when the driving ring 202 is fixed to the base plate 201, each boss portion 202e of the driving ring 202 is located at the front side (one side in the optical axis direction) than each supporting boss portion 201e of the base plate 201.

A center axis CX of each boss portion 202e has a tilt θ2 with respect to the optical axis direction (optical axis AX), and extends in a direction normal to the blade guide surface of the driving ring 202 in this embodiment. An edge portion of the protruding portion of each boss portion 202e is provided more inside in the direction orthogonal to the optical axis direction than the outer diameter (the inner diameter of the base plate 1) of the fixed aperture 201a so as not to contact with the fixed aperture 201a. Therefore, the blade guide surface and each boss portion 202e of the blade guide portion 202b of the driving ring 202 are formed so as to have a diameter within a range equal to or less than the outer diameter of the fixed aperture 201a and equal to or more than an outer diameter of the fixed aperture 202a. This simplified structure makes it possible to dispose the driving ring 202, which is a member that drives each stop blade 203 to change the light-passing aperture, on the rear side (the other side) of each stop blade 203. The structure enables fixing the driving ring 202 with use of at least two rear-side positioning portions to allow the driving ring 202 to drive each of the stop blades 203. This makes it easy to assemble the driving ring 202.

In addition, when driving ring 202 is fixed to the base plate 201, the blade guide surface of the base plate 201 and the blade guide surface of the driving ring 202 are respectively arranged on the outer side and the inner side in the direction orthogonal to the optical axis direction so as to be located along a continuous curved surface (virtual curved surface). In this embodiment, when symbol R1 represents a curvature radius of the blade guide surface of the base plate 201, and symbol R2 denotes a curvature radius of the blade guide surface of the driving ring 202, R1 and R2 satisfy a relation of R2>R1. In other words, from the blade guide surface of the base plate 201 to the blade guide surface of the driving ring 202, an overall curvature becomes smaller toward the fixed aperture 202a of the driving ring 202. This enables each stop blade 203 to be smoothly rotated when they are rotated being sliding to or approaching the blade guide portion 202b of the driving ring 202.

In addition, as described above, while each supporting boss portion 201e of the base plate 201 and each cam boss portion 202e of the driving ring 202 protrude in a direction tilted toward the outer side in the direction orthogonal to the optical axis direction, the tilt θ1 of each supporting boss portion 201e and the tilt θ2 of each boss portion 202e satisfy a relation of θ1>θ2 in accordance with the above-described relation of R2>R1.

The driving ring 202 is positioned with respect to the base plate 201 in the direction orthogonal to the optical axis direction and rotatably supported around the optical axis AX (that is, in the circumferential direction of the light-passing aperture) by the abutment of the outer circumferential surface of the cylindrical portion 202c of the driving ring 202 against the driving ring supporting convex portions 201f formed at the plurality of circumferential places of the base plate 201 (the blade guide portion 201b).

Furthermore, as illustrated in FIG. 13, at part of the circumferential places of the flange portion 202d of the driving ring 202, a driven gear 202f is formed.

Each of the stop blades 203 is, as illustrated in FIG. 16, disposed so as to face (be located along) the blade guide surfaces of the base plate 201 and the driving ring 202. Each stop blade 203 is a thin plate member having a light-blocking property for forming, inside the fixed aperture 202a of the driving ring 202, the stop aperture as the light-passing aperture whose circumference is a light-blocking area.

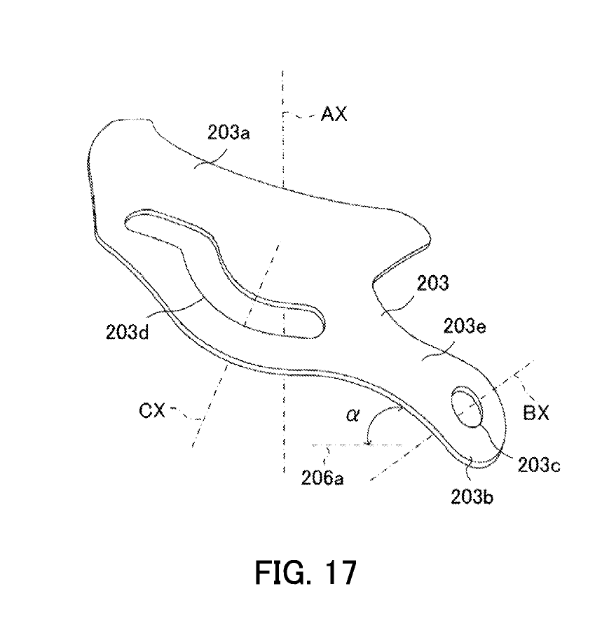

FIG. 17 illustrates details of the shape of each stop blade 203. Each stop blade 203 includes a light-blocking portion 203a as a light-quantity control portion for forming the stop aperture; a stop blade-supported portion 203b rotatably supported by the base plate 201; and an intermediate portion 203e to connect the light-blocking portion 203a and the stop blade-supported portion 203b to each other. A hole portion (concave portion) 203c into which the supporting boss portion 201e formed on the base plate 201 is inserted is formed in the stop blade-supported portion 203b. Each stop blade 203 is rotatable about the supporting boss portion 201e and the hole portion 203c with respect to the base plate 201 (and the driving ring 202).

Each light-blocking portion 203a is formed in the curved surface shape (spherical surface shape) having a curvature approximately the same as that of the blade guide surface of the driving ring 202. For this reason, at the time of the rotation of each stop blade 203, each light-blocking portion 203a is moved in a direction to advance and retract into and from a radially inside area of the fixed aperture 202a of the driving ring 202, being sliding to or approaching the blade guide surface of the driving ring 202, that is, being guided by the blade guide surface. The movement of the light-blocking portion 203a of each of the stop blades 203 in this manner changes a size of the stop aperture (stop aperture diameter) formed by the light-blocking portions 203a. Thereby, quantity of light passing through the stop aperture is controlled. In the following description, a rotation direction of each stop blade 203 for increasing and decreasing the stop aperture diameter is referred to also as “an opening/closing direction” of each stop blade 203.

In addition, the intermediate portion 203e and the stop blade-supported portion 203b of each stop blade 203, that is, at least a portion on a stop blade-supported portion (203b) side than the light-blocking portion 203a has a tilt α with respect to the aperture plane (the direction orthogonal to the optical axis direction) 206a of the stop aperture in the optical axis direction. The tilt α is an angle of certain degrees including 90°. Giving the tilt α to the intermediate portion 203e and the stop blade-supported portion 203b causes the light-blocking portion 203a to be located distant from the stop blade-supported portion 203b in the optical axis direction. In each stop blade 203 of this embodiment, while the light-blocking portion 203a has the tilt with respect to the aperture plane 206a, the intermediate portion 203e and the stop blade-supported portion 203b each has a larger tilt with respect to the aperture plane 206a of the stop aperture in the optical axis direction than that of the light-blocking portion 203a. It is noted that the tilts corresponding to when the light-blocking portion 203a, the intermediate portion 203e and the stop blade-supported portion 203b each have the curved surface shape can each be considered as a tilt of a tangent to the portions.

In addition, on each light-blocking portion 203a, a cam groove portion (concave portion) 203d as an engaged portion into which the boss portion 202e formed on the driving ring 202 is inserted so as to be engaged therewith. As described above, the center axis CX of each boss portion 202e extends in the direction normal to the blade guide surface of the driving ring 202. For this reason, compared to a case where the center axis CX of each boss portion 202e extends in the optical axis direction, each boss portion 202e can smoothly move in the cam groove portion 203d, and each light-blocking portion 203a (that is, each stop blade 203) can be rotated in the opening/closing direction with good positioning accuracy. The provision of the blade guide surface not only to the driving ring 202a, but also to the base plate 201 enables even the stop blade-supported portion 203b of each stop blade 203 to be smoothly rotated. It is noted that the blade guide surface of the driving ring 202a (and the base plate 201) may be formed not in the spherical surface shape, but in a truncated conical surface shape.

Furthermore, the center axis BX of each supporting boss portion 201e inserted into the hole portion 203c formed in the stop blade-supported portion 203b extends in the direction normal to the blade guide surface of the base plate 201. For this reason, each stop blade 203 can be smoothly rotated, compared to a case where the center axis BX of each supporting boss portion 201e extends in the optical axis direction. It is noted that the direction in which each supporting boss portion 201e is tilted with respect to the optical axis direction and the direction in which each boss portion 202e is tilted with respect to the optical axis direction are not necessarily required to be the direction normal to the blade guide surface of the base plate 201 and the direction normal to the blade guide surface of the driving ring 202, respectively.

It is also noted that an entire part of each stop blade 203 from the stop blade-supported portion 203b to the light-blocking portion 203a may be formed in the curved surface shape (spherical surface shape).

Similarly to the aperture stop apparatus of this embodiment, in a case where the driving ring 202a has the domical shape, and each stop blade 203 is disposed along an outer surface of the domical shape, a configuration is possible in which the driving ring 202 and each stop blade are fixed to the base plate 201 in this order from the same side (front side) in the optical axis direction (hereinafter, referred to as “a comparative example”). However, in the comparative example, it is necessary to provide a portion to position the driving ring 202 in the optical axis direction and in the direction orthogonal to the optical axis direction, on the outer side of the base plate 201 in the direction orthogonal to the optical axis direction than each supporting boss portion provided on the side (front side). Otherwise, it is necessary to provide a portion extending toward the inner side in the direction orthogonal to the optical axis direction than an outer circumference (outer edge) of the portion on which each boss portion serving as the cam of the driving ring 202a is provided, in order to position the driving ring 202a in the optical axis direction and in the direction orthogonal to the optical axis direction at a side (rear side) opposite to the side (front side) on which each boss portion serving as the cam of the driving ring 202a is provided. This results in an increase in size of the aperture stop apparatus in the optical axis direction and the direction orthogonal to the optical axis direction (radial direction) and in a decrease in diameter and depth of the concave space.

In contrast to this, in this embodiment, in the optical axis direction, the driving ring 202 is fixed to the base plate 201 from a direction (the rear side, which is the other surface side) opposite to the direction (from the front side, which is one surface side) in which each stop blade 203 is fixed to the base plate 201. This makes it possible to use the driving ring positioning surface 201d, which is a portion of the base plate 201 provided on the side (rear side) opposite to the side (front side) on which each supporting boss portion 201e is provided, for the positioning of the driving ring 202 with respect to the base plate 201 in the optical axis direction. Furthermore, in this embodiment, the driving ring supporting convex portion 201f provided in the direction orthogonal to the optical axis direction on the inner side (inner circumferential surface) of the blade guide portion 201b, which is a portion of the base plate 201 on which each supporting boss portion 201e is provided, abuts against the outer circumferential surface of the cylindrical portion 202a, which is a portion extending backward from (outermost circumferential portion of) the blade guide portion 202b, which is a portion of the driving ring 202 on which each boss portion 202e is provided. This makes it possible to position the driving ring 202 with respect to the base plate 201 in the optical axis direction.

For this reason, according to this embodiment, it is not necessary to provide the portion to position the driving ring 202 in the optical axis direction and in the direction orthogonal to the optical axis direction, on the outer side of the base plate 201 in the direction orthogonal to the optical axis direction than each supporting boss portion 201e. This enables miniaturizing the base plate 201. Moreover, it is not necessary to form, on the base plate 201, a portion extending toward the inner side in the direction orthogonal to the optical axis direction than an outer edge of the blade guide surface on which each cam boss portion 202e of the driving ring 202 is provided, in order to position the driving ring 202 in the optical axis direction and in the direction orthogonal to the optical axis direction at a portion opposite to the side on which each boss portion 202e of the driving ring 202 is provided. This enables miniaturizing the base plate 201.

In addition, a portion at which each stop blade 203 and the driving ring 202 are engaged with each other is located on a fixed aperture (201a) side than each supporting boss portion 201e (an outer side in the direction orthogonal to the optical axis direction than the fixed aperture 202a), which enables rotating each stop blade 203 with the simplified structure. Therefore, particularly in a case where the stop blades forming the concave space are used similarly to this embodiment, it is possible to, compared to the comparative example, increase a diameter and a depth of the concave space S while reducing the size of the aperture stop apparatus in the optical axis direction and in the direction orthogonal to the optical axis direction (radial direction).

A front cover plate (first cover member) 204 is disposed on the front side than the base plate 201 and forms a stop blade room for housing each stop blade 203 between the front cover plate 204, and the base plate 201 and the driving ring 202 (the blade guide portion 202b). On an inner circumferential portion of the front cover plate 204, a domical portion (blade cover portion) 204b having a domical shape convex toward the front side is formed. The domical portion 204b has a curved surface shape (spherical surface shape) with a curvature approximately the same as that of the blade guide surface of the driving ring 202. On a front end of the domical portion 204b, a fixed aperture 204a is formed whose diameter is larger than that of the fixed aperture 202a of the driving ring 202 and smaller than that of the fixed aperture 201a of the base plate 201. The front cover plate 204 is, at its outer circumferential portion, coupled with the base plate 201 using screws, and thereby the front cover plate 204 is integrated with the base plate 201. The front cover plate 204 may be fixed to the base plate 201 not by using the screws, but by thermal calking.

Reference numeral 205 denotes a driver including an actuator such as a stepping motor. A driving gear 205a engaged with the driven gear 202f of the driving ring 202 is fixed to an output shaft of the driver 205. The driver 205 is fixed to the base plate 201 through a motor base plate 205b. Specifically, the driver 205 is fixed to the flange portion 201c of the base plate 201 by screws 206 across a flange portion located on the outer side of the front cover plate 204 in the direction orthogonal to the optical axis direction than the domical portion 204b. That is, the driver 205 is provided so as to protrude in the same direction as that in which the blade guide portion 202b of the driving ring 202, each stop blade 203 and the domical portion 204b of the front cover plate 204 protrude toward a circumferential portion thereof (hereinafter, referred to as “a domical portion protruding direction”), from the circumferential portion. The disposition of the driver 205 in the domical portion protruding direction than the base plate 201 enables, when the aperture stop apparatus 210 is installed in the optical apparatus such as the camera similarly to Embodiment 4 described later, effectively using a space in the optical apparatus (in particular, a space opposite to the domical portion protruding direction with respect to the aperture stop apparatus 210). This enables miniaturizing the optical apparatus.

A rear cover plate (second cover member) 207 is disposed on the rear side than the base plate 201 and is fixed to the flange portion 201c of the base plate 201 by using the screws so as to cover a rear surface of each of the flange portion 201c of the base plate 201 and the flange portion 202d of the driving ring 202. On an inner circumferential portion of the rear cover plate 207, a fixed aperture 207a having an inner diameter approximately the same as the inner diameter of the flange portion 202d of the driving ring 202. The fixed aperture 207a serves as a rear end aperture of the concave space S. In addition, the rear cover plate 207 abuts against the protruding portion 202d″ formed on the rear surface of the flange portion 202d of the driving ring 202 to retain the driving ring 202 forward with respect to the base plate 201 (prevent the driving ring 202 from dropping off rearward from the base plate 201). The rear cover plate 207 may be fixed to the base plate 201 not by the screws, but by the thermal calking.

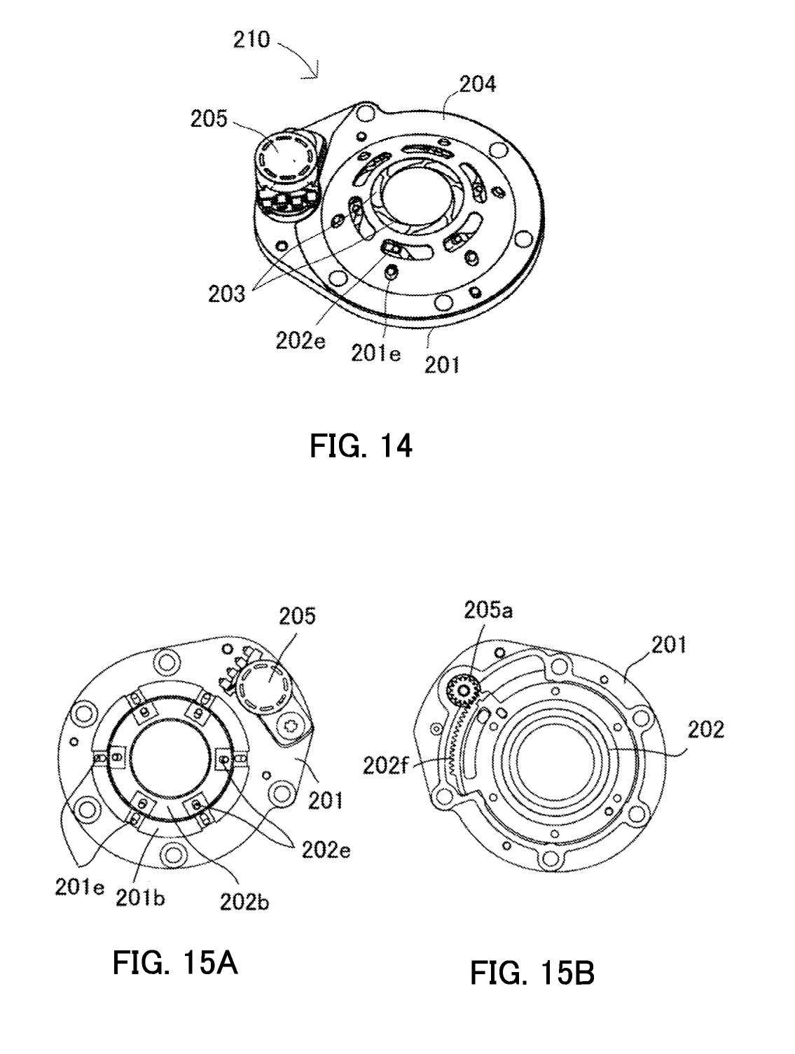

FIG. 14 illustrates the aperture stop apparatus 210 with the above-described configuration that has been assembled. FIGS. 15A and 15B illustrate the base plate 201 to which the driving ring 202 and the driver 205 are fixed, as viewed from the front side and the rear side, respectively.

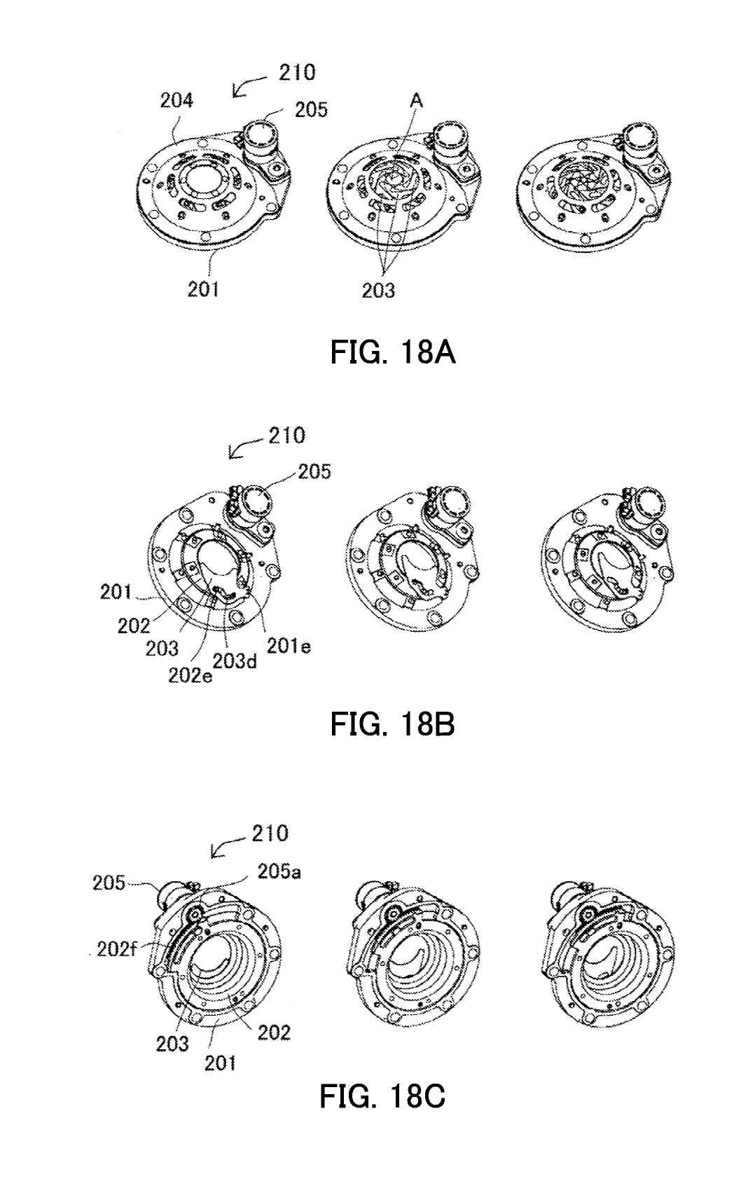

Furthermore, FIGS. 18A, 18B and 18C illustrate an operation of the aperture stop apparatus 210 of this embodiment. FIG. 18A illustrates the operation of the aperture stop apparatus 210, and FIGS. 18B and 18C illustrate one stop blade 203 being rotated, as viewed from the front side and the rear side of the aperture stop apparatus 210, respectively.

When the driver 205 is energized and thereby the driving gear 205a is rotated, a rotational force from the driver 205 is transmitted to the stop driving ring 202 through the driven gear 202f and rotates the stop driving ring 202 about the optical axis AX with respect to the base plate 201. With the rotation of the stop driving ring 202, each cam boss portion 202e provided in the stop driving ring 202 moves in the cam groove portion 203d formed in the light-blocking portion 203a of each stop blade 203. Therefore, each stop blade 203 is rotated in the opening/closing direction about the supporting boss portion 201e inserted into the hole portion 203c of the stop blade-supported portion 203b. The rotation of each of the stop blades 203 in this manner changes the size of the stop aperture A formed by the light-blocking portions 203a of the stop blades 203. Thereby, quantity of the light passing through the stop aperture is controlled.

It is noted that although this embodiment described the case where each supporting boss portion 201e formed on the base plate 201 and each cam boss portion 202e formed on the driving ring 202 are respectively inserted into the hole portion 203c and the cam groove portion 203d both formed on each stop blade 203, boss portions corresponding to the supporting boss portions 201e and boss portions corresponding to the cam boss portions 202e may be formed on each stop blade 203 and may be respectively inserted into the hole portions 203c formed on the base plate 201 and the cam groove portions 203d formed on the driving ring 202.

It is also noted that although this embodiment described the case where the blade guide portion 202b of the driving ring 202 is formed in the curved surface shape (spherical surface shape) continuous in the circumferential direction, the blade guide portion 202b may be formed in a plurality of radially rails extending in the direction orthogonal to the optical axis direction.

It is moreover noted that this embodiment described the case where the driving ring 202a has the domical shape and each stop blade 203 is disposed along the outer surface of the domical shape, each boss portion formed on the driving ring and each supporting boss portion formed on the base plate may have an approximately the same height by using flat-shaped stop blades. In this configuration, it is enough that each supporting boss portion of the base plate and each boss portion of the driving ring are formed so as to extend in the optical axis direction, the supporting boss portion of the hole portion of each stop blade-supported portion of the base plate is inserted from the optical axis direction, and each boss portion of the driving ring is inserted into the hole portion of each stop blade from the optical axis direction. In this configuration, the stop blades are disposed so as to overlap with one another over the base plate and the driving ring in the optical axis direction and are supported by the base plate and the driving ring at the two points on one surface side in the optical axis direction. This enables the stop blades to be stably rotated in the direction orthogonal to the optical axis direction.

It is noted that the light-quantity control apparatuses described in (1) and (2) above may have the following alternative configurations.

(3) A light-quantity control apparatus according to (1), in which the blade driving member is fixed to the base member from, of an optical axis direction, a direction opposite to a direction in which the light-quantity control blade is fixed to the base member.

(4) A light-quantity control apparatus according to (1) or (3), in which the light-quantity control blade has a shape in which the light-quantity control portion is located distant from the supported portion at one side in the optical axis direction such that a concave space having a depth toward the aperture portion more inside in a direction orthogonal to the optical axis direction than the light-quantity control blade is formed.

(5) A light-quantity control apparatus according to (2), in which the blade driving member abuts against a portion of the base member opposite to a side on which the blade supporting portion is provided and is thereby positioned with respect to the base member.

(6) A light-quantity control apparatus according to (2) or (5), in which, in a direction orthogonal to the optical axis direction, the blade driving member is positioned with respect to the base member by abutment of a portion extending in the optical axis direction from a portion of the blade driving member on which the blade engaging portion is provided against an inner side of a portion of the base member on which the blade supporting portion is provided.

(7) A light-quantity control apparatus according to any one of (2), (5) and (6), in which the blade driving member is fixed to the base member such that the blade engaging portion is located on the one side than the blade supporting portion.

(8) A light-quantity control apparatus according to (7), in which: at least the light-quantity control portion of the light-quantity control blade has a curved surface shape; the base member and the blade driving member are each a surface on which the light-quantity control blade is rotated being sliding or approaching and respectively have a base-member-side blade guide surface and a driving-member-side blade guide surface, both of which has a curved surface shape; the base-member-side blade guide surface and the driving-member-side blade guide surface are respectively disposed on an outer side and an inner side in the direction orthogonal to the optical axis direction; and a curvature radius of the driving-member-side blade guide surface is larger than a curvature radius of the base-member-side blade guide surface.

(9) A light-quantity control apparatus according to any one of (4) to (8), in which: of the light-quantity control blade, the supported portion and an engaged portion with which the blade engaging portion is engaged each has a tilt with respect to the aperture plane in the optical axis direction; one of the supported portion and the blade supporting portion is formed as a protruding portion inserted into a concave portion of the other; one of the engaged portion and the blade engaging portion is formed as a protruding portion inserted into a concave portion of the other; and each of the protruding portions is formed so as to be tilted with respect to the optical axis direction.

(10) A light-quantity control apparatus according to any one of (1) to (9), in which the blade engaging portion between the light-quantity control blade and the blade driving member are constituted by an engaging portion provided on the blade driving member and an engaged portion of the light-quantity control blade; and the engaging portion provided on the blade driving member is constituted by a protruding portion provided on an inner side of the aperture portion.

### Embodiment 4

FIG. 28A illustrates a camera (video camera or still camera) as an optical apparatus on which the light-quantity control apparatus (aperture stop apparatuses 110 or 210 or aperture stop/shutter apparatus 10) described in Embodiments 1 to 3 is mounted. Reference numeral 50 denotes a camera body (optical apparatus body), and reference numerals 51 and 53 denote a plurality of lenses included in an image pickup optical system. The image pickup optical system is housed in a lens barrel of the camera body 50. Reference numeral 52 denotes an image sensor that includes a CCD sensor and a CMOS sensor and photoelectrically converts an object image formed through the image pickup optical system.

Reference numeral 54 denotes a controller that includes a CPU and controls operations of the driver (105, 5, 205) of the light-quantity control apparatus (110, 10, 210) and the image sensor 52.

In such a camera, as illustrated in FIGS. 3, 8 and 16, at least part of the lens 51 (convex surface) arranged adjacently to the light-quantity control apparatus in the optical axis direction can be inserted into the concave space S of the light-quantity control apparatus (110, 10, 210). FIGS. 3, 8 and 16 illustrate that an opening into the concave space S for the lens 51 opens toward an image plane side, and the lens 51 (and a lens holder 52 holding the lens 51 in FIG. 8) arranged adjacently to the light-quantity control apparatus and closer to the image plane side than the light-quantity control apparatus is inserted into the concave space S.

The opening into the concave space S for a lens may open toward an object side so as to allow the lens 53 arranged adjacently to the light-quantity control apparatus and closer to the object side than the light-quantity control apparatus to be inserted into the concave space S.

Such an arrangement enables the image pickup optical system of the camera to be downsized in the optical axis direction, in particular.

A size (inner diameter) of the back-end aperture as the opening into the concave space S for the lens 51 basically depends on a circle passing through the supported portions (supporting boss portion) of the stop blades and does not depend on the size of the stop aperture formed by the stop blades. Thus, when the stop aperture is narrowed down, the lens can be inserted into the concave space S without opening the stop aperture to a fully-opened aperture diameter or beyond that. This eliminates the need for increasing a maximum diameter of the stop aperture in accordance with the outer diameter of the lens 51, thereby preventing a size of the light-quantity control apparatus having an inner space in which the lens can be inserted from increasing in the direction (radial direction) orthogonal to the optical axis.

FIGS. 3, 8 and 16 illustrate that a convex surface (domical shape surface) on the object side of the cover plate (104, 4, 204) of the light-quantity control apparatus (110, 10, 210) and a concave surface on the image plane side of the lens 53 disposed closer to the object side than the convex surface are close to each other. Thereby, it is possible to arrange the stop blades 103 and 3 and the shutter blades 21 and 22 in a narrow space between the convex surface on the object side of the lens 51 and the concave surface on the image plane side of the lens 53.

As illustrated with arrows in FIGS. 3 and 8, while the light-quantity control apparatus (110, 10, 210) is close to the lenses 51 and 53 on both sides thereof, the lens barrel holding the image pickup optical system may be housed (retracted) in the camera body.

The light-quantity control apparatus (110, 10, 210) can be mounted not only on the camera illustrated in FIG. 28A but also on any other optical apparatus such as an interchangeable lens.

### Embodiment 5

An optical apparatus such as a camera is necessary to have compactness. In particular, when a lens barrel for holding an image taking lens protrudes from a camera body in its optical axis direction, it is necessary to reduce a length of the lens barrel in the optical axis direction as short as possible. Some image taking lens includes a light-quantity control apparatus (aperture stop apparatus or aperture stop/shutter apparatus) that controls quantity of light reaching at an image plane, and an optical image stabilizing apparatus that shifts a correcting lens in a direction orthogonal to the optical axis to reduce image blur due to hand shake.

Japanese Patent Laid-open No. 2007-94074 discloses a light-quantity control apparatus in which a light-quantity control blade including a protruding portion having a curved surface shape (spherical surface shape) slides in a direction orthogonal to an optical axis direction so as to change a size of an opening through which light passes. The protruding portion included in the light-quantity control blade forms a concave space (semispherical space) in which a lens is housed. This enables the image taking lens (lens barrel) to have a shorter length in the optical axis direction.

In the apparatus disclosed in Japanese Patent Laid-open No. 2007-94074, the light-quantity control blade is retracted in the direction orthogonal to the optical axis direction, facilitating downsizing in the optical axis direction. However, a retraction space for the light-quantity control blade is necessary to have a thickness larger than that of the light-quantity control blade including the protruding portion, which makes it difficult to provide other drivers.

Thus, light-quantity control apparatuses described below are required.

(1) A light-quantity control apparatus includes a light-quantity control blade movable along a curved path formed between a first optical member and a second optical member, and an apparatus body including a blade driver configured to drive the light-quantity control blade along the curved path. The apparatus body is provided with a shake correction unit.

(2) A light-quantity control apparatus includes a base member; a light-quantity control blade including a light-quantity controller to form a light-passing aperture and a supported portion rotatably supported by the base member; a rotational driving member rotatably supported in a circumferential direction of the light-passing aperture by the base member and configured to rotate to rotate the light-quantity control blade; a blade driver configured to rotate the rotational driving member; and a shake correction driver configured to shift, when a direction orthogonal to an aperture plane of the light-passing aperture is defined as an optical axis direction, an optical material that shifts with respect to the base member in the direction orthogonal to the optical axis direction to reduce image blur. The light-quantity control blade has such a shape that the light-quantity controller is located distant from the supported portion in the optical axis direction so as to form a concave space having a depth from the light-quantity control blade toward the light-passing aperture. The blade driver and the shake correction driver are arranged at positions different from each other in a plane orthogonal to the optical axis direction and on a side opposite with respect to the base member in the optical axis direction to a side on which the light-quantity control blade is arranged. At least part of the optical material is disposed inside the concave space and configured to shift inside the concave space.

According to the light-quantity control apparatus described in each of (1) and (2), applying a light-quantity control blade having a curved surface shape and providing an shake correction unit suitable for the light-quantity control blade can achieve downsizing in the optical axis direction, a light-quantity control function and an shake correction function. This can thus achieve downsizing of an optical apparatus on which the light-quantity control apparatus is mounted.

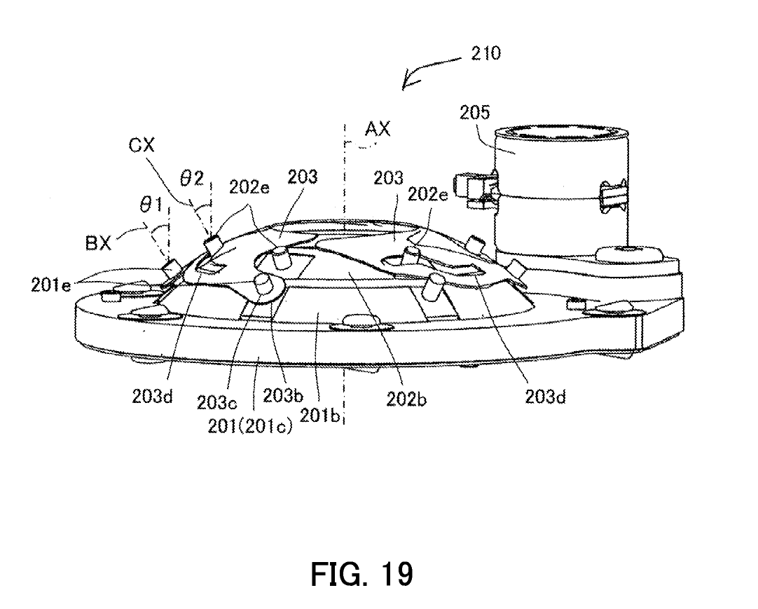

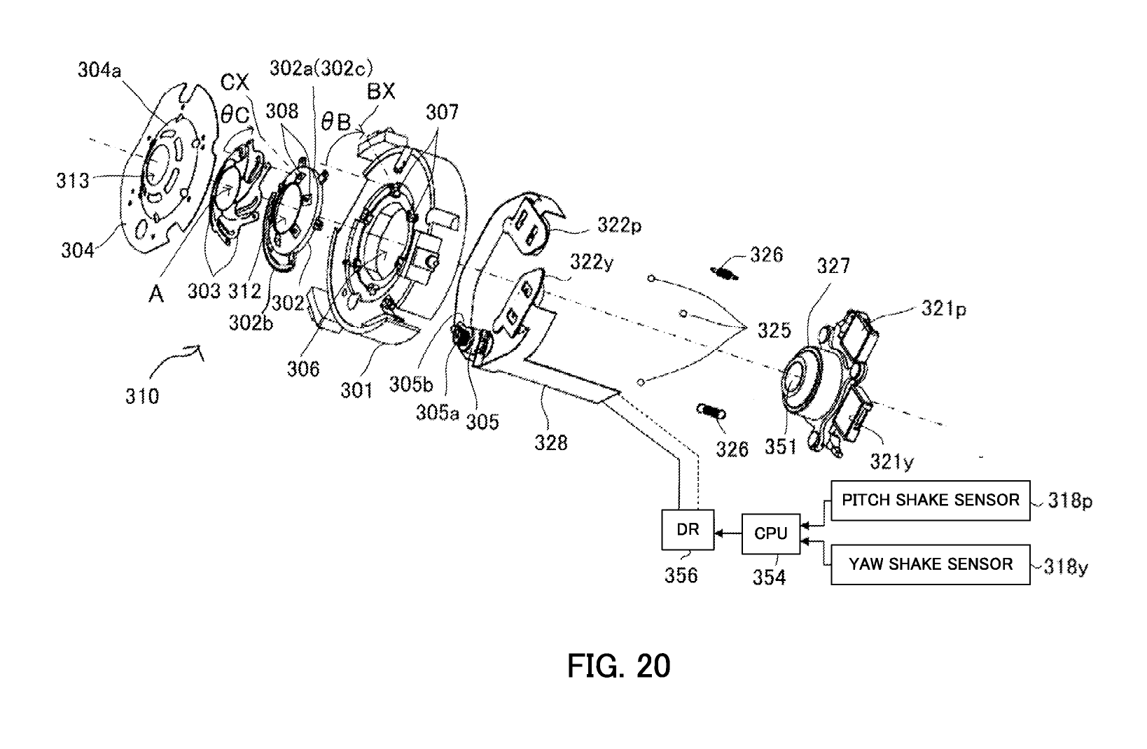

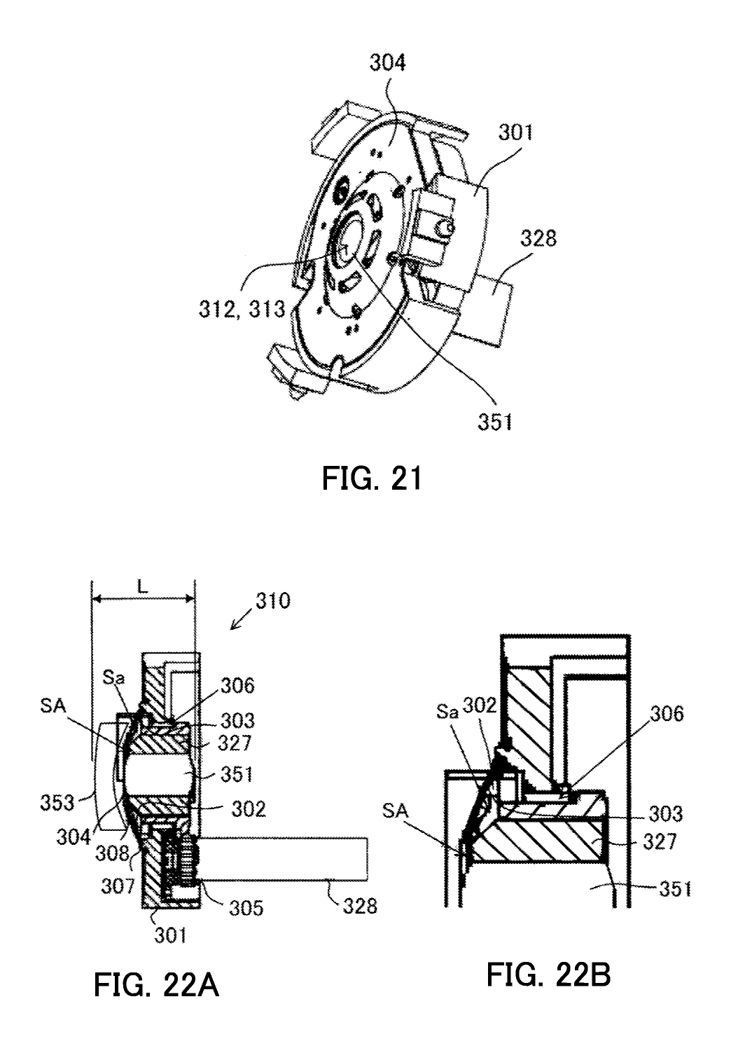

FIGS. 20 and 21 illustrate an aperture stop apparatus 310 as a light-quantity control image stabilizing apparatus in Embodiment 5 of the present invention. This aperture stop apparatus 310 includes an iris aperture stop mechanism and a shake correction mechanism (optical image stabilizing mechanism). In FIGS. 20 and 21, reference numeral 301 denotes a base plate as a ring shaped base member in which central portion an opening 306 is formed. Hereinafter, the optical axis AX is defined as an axis that passes centers of an opening plane of the opening 306 and aperture planes of fixed apertures and a stop aperture described later and is orthogonal to the planes. A direction in which the optical axis AX extends is defined as an optical axis direction. In addition, the radial direction is defined as a direction orthogonal to the optical axis direction. In FIGS. 20 and 21, a left side (one side in the optical axis direction, a side on one surface of the base plate 301) is referred to as a “front side”, and a right side (the other side in the optical axis direction, a side on the other surface of the base plate 301) is referred to as a “rear side”.

The base plate 301 has a ring portion that surrounds the opening 306 and on which stop blade-supporting boss portions (protruding portions) 307 as blade support portions are formed at a plurality of positions in a circumferential direction. A center axis BX of each stop blade-supporting boss portion 307 has a tilt angle θB with respect to the optical axis direction (optical axis AX).

Reference numeral 302 denotes a stop driving ring as a rotational driving member. The stop driving ring 302 includes a domical wall portion 302a formed in a domical shape that is concave toward the base plate 301 (opening 306) (in other words, convex toward an opposite side to the base plate 301). The domical wall portion 302a has a fixed aperture 312 formed on its innermost circumferential portion (diametric center portion). The stop driving ring 302 has a driven gear 302b formed on part of its outer circumferential side portion than the domical wall portion 302a, the part being along the circumferential direction. A concave surface of the domical wall portion 302a closer to the base plate 301, and a convex surface (hereinafter, referred to as a stop guide surface) 302c opposite to the concave surface are each formed in a curved surface shape (for example, a spherical surface shape). An aperture plane of the fixed aperture 312 is located more distant from the base plate 301 (opening plane of the opening 306) in the optical axis direction than an outer circumference edge of the domical wall portion 302a of the stop driving ring 302. In other words, the domical wall portion 302a of the stop driving ring 302 is formed so as to protrude in a direction distant from the base plate 301 in the optical axis direction (that is, so as to have a shape that is concave toward one side in the optical axis direction from the outer circumferential side portion of the stop driving ring 302 to its inner circumferential side).

The stop guide surface 302c of the domical wall portion 302a has boss portions (protruding portions) 308 as convex blade-engaging members formed at a plurality of positions (a plurality of positions around the fixed aperture 312) in the circumferential direction. A center axis CX of each boss portion 308 has a tilt angle θC with respect to the optical axis direction (optical axis AX) so as to extend in a direction normal to the stop guide surface 302c.

Reference numeral 303 denotes a stop blade as a light-quantity control blade and is one of a plurality (six) of light-quantity control blades provided in this embodiment. The stop blade 303 is a thin plate member having a light-blocking property to form a stop aperture A as a light-passing aperture around which light is blocked at an inner position along a direction orthogonal to the optical axis direction than the fixed aperture 312 formed on the stop driving ring 302.

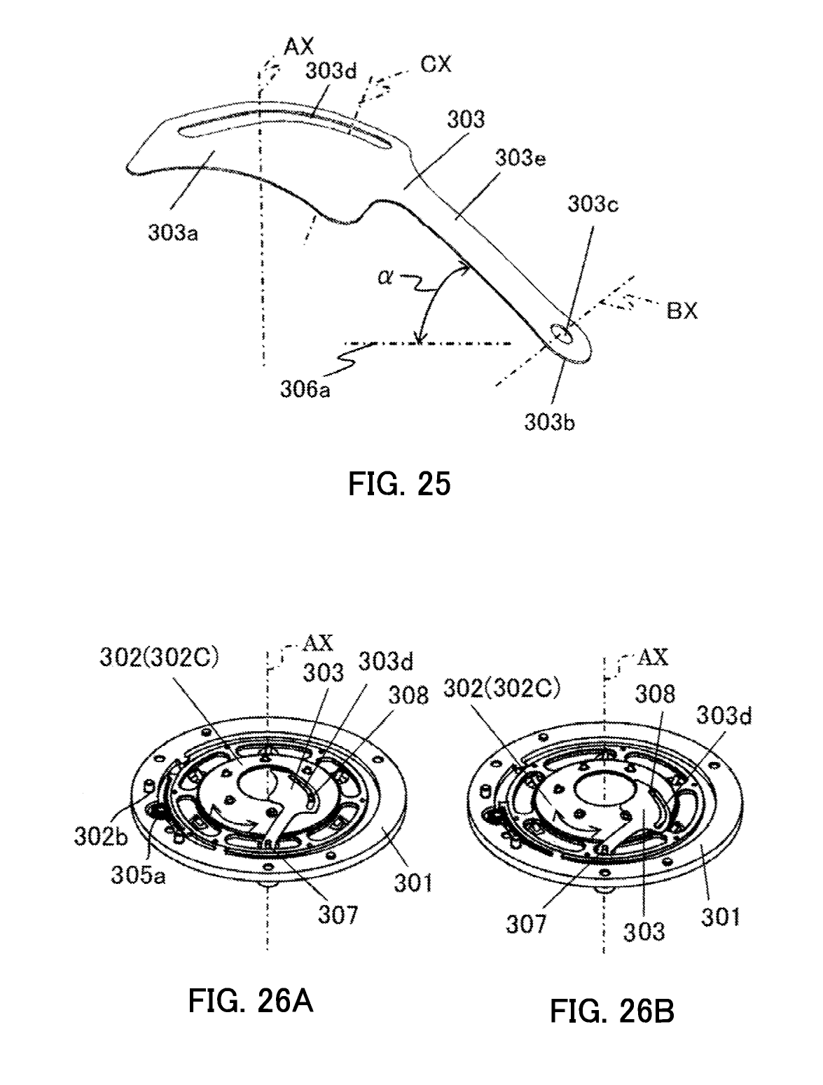

As illustrated in detail in FIG. 25, the stop blade 303 includes a stop portion 303a as a light-quantity controller to form the stop aperture A, and a supported portion 303c provided with a hole portion 303c into which the stop blade-supporting boss portion 307 of the base plate 301 is inserted. A supported portion 303b (that is, the stop blade 303) is supported rotatably about the stop blade-supporting boss portion 307 by the base plate 301 when the stop blade-supporting boss portion 307 is inserted in the hole portion 303c. The stop blade 303 further includes an intermediate portion 303e connecting the stop portion 303a and the supported portion 303b.

Each stop blade 303 is disposed to face (or extend along) the stop guide surface 302c of the domical wall portion 302a of the stop driving ring 302. The stop portion 303a is formed in a curved surface shape (for example, a spherical surface shape) having approximately the same curvature as that of the stop guide surface 302c of the domical wall portion 302a. Therefore, when the stop blade 303 is rotated, the stop portion 303a is rotated in a direction to advance and retract in an inside region (a region facing the fixed aperture 312) in a direction orthogonal to the optical axis direction of the fixed aperture 312 along the stop guide surface 302c while the stop portion 303a is guided by the stop guide surface 302c. This changes a size of the stop aperture. Hereinafter, a direction of the rotation of the stop blade 303 is referred to as a stop opening/closing direction.

The intermediate portion 303e and the supported portion 303b of each stop blade 303, that is, at least part of the stop blade 303 closer to the supported portion 303b than the stop portion 303a has a tilt α in the optical axis direction with respect to the opening plane (denoted by reference numeral 306a in FIG. 25) of the opening 306 of the base plate 1. Since this tilt α corresponds to a tilt with respect to the aperture plane of the fixed aperture 312 formed on the stop driving ring 302, an aperture plane of a fixed aperture formed on a stop cover plate described later, and an aperture plane of the stop aperture A, and each aperture plane is aligned along the direction orthogonal to the optical axis direction, the tilt is with respect to the radial direction.

The tilt α is set to be equal to or smaller than 90°. Giving the tilt α to the intermediate portion 303e and the supported portion 303b causes the stop portion 303a to be located distant from the supported portion 303b in the optical axis direction. In addition, a center axis of the hole portion 303c formed on the supported portion 303b has a tilt with respect to the optical axis AX so as to match a center axis BX of the stop blade-supporting boss portion 307. Therefore, it is possible to more smoothly rotate the stop blade 303 compared to a case where the center axis of the stop blade-supporting boss portion 307 extends in the optical axis direction.

In this embodiment, the stop portion 303a has a tilt (tilt of a tangent line of the stop portion 303a in the curved surface shape) with respect to the opening plane 306a. The intermediate portion 303e and the supported portion 303b have larger tilts in the optical axis direction with respect to the opening plane 306a (the radial direction) than the stop portion 303a. In other words, the stop portion 303a has a smaller tilt in the optical axis direction with respect to the opening plane 306a than the tilt of the supported portion 303b. The entire stop blade 303 from the supported portion 303b to the stop portion 303a may be formed in a curved surface shape (for example, a spherical surface shape).

In addition, a cam groove 303d in which the cam boss portion 308 formed on the stop driving ring 302 is inserted and which engages therewith is formed in the stop blade 303. As described above, the center axis CX of the cam boss portion 308 extends in the direction normal to the stop guide surface 302c. Thus, the cam boss portion 308 can move more smoothly in the cam groove 303d compared to a case where the center axis of the cam boss portion 308 extends in the optical axis direction, so as to accurately rotate the stop portion 303a (that is, the stop blade 303) in the stop opening/closing direction. The stop portion 303a is formed in a curved surface shape (for example, a spherical surface shape), and the stop guide surface 302c may be formed in a truncated conical surface shape instead of a curved surface shape.

In FIG. 20 and In FIG. 21, reference numeral 304 denotes a stop cover plate (stop cover member) that is disposed on an opposite side to the base plate 301 with respect to the stop driving ring 302 and the stop blade 303 and forms a stop blade room to house the stop blade 303 between the stop cover plate 304 and the stop driving ring 302 (domical wall portion 302a). The stop cover plate 304 includes a domical wall portion 304a formed in a domical shape that is concave toward the base plate 301 (opening 306) (in other words, convex toward an opposite side to the base plate 301), and a ring portion formed on an outer circumference of the domical wall portion 304a. The domical wall portion 304a is formed in a curved surface shape (for example, a spherical surface shape) having approximately the same curvature as that of the domical wall portion 302a of the stop driving ring 302. An apparatus body of the aperture stop apparatus 310 includes the base plate 301 and the stop driving ring 302 and houses the stop blade 303 at least.

A fixed aperture 313 is formed in an innermost circumferential portion (center portion in a direction orthogonal to the optical axis direction) of the domical wall portion 304a. In the optical axis direction, an aperture plane of the fixed aperture 313 is located distant from the base plate 301 (opening 306) relative to an outer circumferential edge portion (ring portion) of the domical wall portion 304a. That is, the domical wall portion 304a of the stop cover plate 304 is formed so as to protrude in a direction distant from the base plate 301 in the optical axis direction.

The stop cover plate 304 is integrated with the base plate 301 by connecting the ring portion of the stop cover plate 304 to the base plate 301 by a screw. Thus, similarly to the base plate 301, the stop cover plate 304 can be treated as a base member.

Reference numeral 305 denotes a stop driver (blade driver) including an actuator such as a stepping motor. A driving gear 305a meshing with the driven gear 302b of the stop driving ring 302 is fixed to an output shaft of the stop driver as illustrated in FIG. 26A. The stop driver 305 is fixed (installed) to the base plate 301 via a motor base plate 305b. The stop driver 305 is disposed on a plane orthogonal to the optical axis direction on an opposite side to the stop cover plate 304 with respect to the base member as the base plate 301. In other words, the stop driver 305 is disposed so as to protrude in an opposite direction to a convex shape of the stop cover plate 304.

When the stop driver 305 is energized and thereby the driving gear 305a is rotated, as illustrated in FIGS. 26A and 26B, a rotational force from the stop driver 305 is transmitted to the stop driving ring 302 through the driven gear 302b and the driving gear 305a and rotates the stop driving ring 302 about the optical axis AX (around the light-passing aperture) with respect to the base plate 301. With the rotation of the stop driving ring 302, the cam boss portion 308 provided in the stop driving ring 302 moves in the cam groove 303d formed in the stop portion 303a of each stop blade 303. Therefore, each stop blade 303 is rotated in the stop opening/closing direction about the stop blade-supporting boss portion 307 inserted into the hole portion 303c of the supported portion 303b. In this manner, the rotation of the stop portion 303a of the stop blades 303 (only one stop blade 303 is illustrated in FIGS. 26A and 26B) in the stop opening/closing direction changes a diameter of the stop aperture A formed by the stop portions 303a, which increases and decreases (controls) a quantity of light passing through the stop aperture A.

It is noted that, although this embodiment described the case where (the center axis BX of) the stop blade-supporting boss portion 307 formed in the base plate 301 and (the center axis CX of) the cam boss portion 308 formed in the stop driving ring 302 are tilted with respect to the optical axis direction, the stop blade-supporting boss portion 307 and the cam boss portion 308 may be formed to extend in parallel with the optical axis direction as long as the stop blade 303 (supported portion 303b) is rotated with respect to a virtual axis tilted with respect to the optical axis direction.

Moreover, a domical wall portion similar to the domical wall portion 304a of the stop cover plate 304 may be formed in the base plate 301, and a fixed aperture may be formed in the domical wall portion. In addition, a cam boss portion to be inserted into the cam groove may be formed in an inner surface (concave surface) of the domical wall portion, and a stop blade-supporting boss portion may be formed in the rotatable stop driving ring 2. In this case, the stop blade-supporting boss portion formed in the stop driving ring 302 is inserted into the hole portion 303c formed in the stop blade 303, and the cam boss portion formed in the domical wall portion of the base plate 301 is inserted into the cam groove 303d. Also in such a configuration, rotating the stop driving ring 302 can rotate the stop blade 303 in the stop opening/closing direction.

In this manner, as long as relative positions of the stop blade-supporting boss portion and the cam boss portion respectively inserted into the hole portion 303c and the cam groove 303d of the stop blade 303 are changeable, any one of the stop blade-supporting boss portion and the cam boss portion may be formed in the base plate 301 and the other thereof may be formed in the stop driving ring 302. Even when the stop driving ring 302 directly supports the stop blade-supported portion 303b of the stop blade 303 in this manner, it is common that the stop blade-supported portion 303b is rotatably supported with respect to the base plate 301.

Although this embodiment described the case where the stop blade-supporting boss portion 307 formed in the base plate 301 and the cam boss portion 308 formed in the stop driving ring 302 are respectively inserted into the hole portion 303c and the cam groove 303d formed in the stop blade 303, a boss portion corresponding to the stop blade-supporting boss portion 307 and a boss portion corresponding to the boss portion 308 may be formed in the stop blade 303 to insert them into a hole portion formed in the base plate 301 and a cam groove formed in the stop driving ring 302.

In the aperture stop apparatus 310 in this embodiment including the shake correction mechanism, as described above, the stop blade 303 has such a shape that the stop portion 303a is located distant from the supported portion 303b in the optical axis direction. Thus, as illustrated in FIG. 22A and FIG. 22B of an enlarged view of part of FIG. 22A, when a space between a concave lens 353 as the first optical member and a correcting lens 351 as the second optical member described later and a shift frame 327 is referred to as a concave space SA, a curved path through which the stop blade 303 moves is formed in the concave space SA. An opening is formed across the circumferential direction at end portions of the first and second optical members, and the stop blade 303 driven by the stop driver moves in the concave space SA in the opening. A concave shake correction space Sa having a depth from the opening 306 of the base plate 301 toward the stop aperture (light-passing aperture) A and the fixed apertures 312 and 313 is formed more inside in the direction orthogonal to the optical axis direction than the stop blade 303.

In practice, the shake correction space Sa is formed more inside in the direction orthogonal to the optical axis direction than the stop driving ring 302. An opening (back-end opening) on the base plate 301 side of the shake correction space Sa is connected with an inner space of the opening 306 of the base plate 301. The shake correction space Sa has a convex shape toward a front side thereof and houses at least part (in this embodiment, a convex surface on the front side) of the correcting lens 351 described later that is disposed inside the opening 306 of the base plate 301. The shake correction space Sa is included in the concave space SA that houses at least part of the correcting lens 351.

Next, with reference to FIGS. 20 and 24, a description will be made of the shake correction mechanism of the aperture stop apparatus 310 in this embodiment, and an electric system (image stabilizing system) provided to an optical apparatus on which the aperture stop apparatus 310 is mounted to operate the shake correction mechanism. FIG. 24 illustrates the aperture stop apparatus 310 when viewed from a right side (rear side) in FIG. 20.

First, a description will be made of an optical shake correction mechanism. Hereinafter, shake correction is also referred to as image stabilization. Reference numeral 327 denotes a shift frame holding the correcting lens 351 as an image stabilizing optical element and disposed movable in a pitch (vertical) direction and a yaw (horizontal) direction that are orthogonal to the optical axis direction on an opposite side to the stop driving ring 302 and the stop blades 303 with respect to the base plate 301. A pitch magnet 321p and a yaw magnet 321y are attached to the shift frame 327 with their phases being 90° different from each other around the optical axis AX. Reference numeral 322p denotes a pitch coil, and reference numeral 322y denotes a yaw coil. The pitch and yaw coils 322p and 322y are attached at positions different from that of the stop driver 305 around the optical axis AX in a plane orthogonal to the optical axis direction on an opposite side to a surface of the base plate 301 on which the stop driving ring 302 and the stop blade 303 are disposed, that is, the surface to which the stop driver 305 is attached. The pitch and yaw coils 322p and 322y are attached at such positions that their phases are 90° different from each other. As illustrated in FIG. 24, the shift frame 327 is disposed such that the pitch magnet 321p and the yaw magnet 321y respectively face the pitch coil 322p and the yaw coil 322y in the optical axis direction. The pitch magnet 321p, the yaw magnet 321y and the stop driver 305 are connected with a flexible substrate 328.

Three balls 325 are disposed between the base plate 301 and the shift frame 327. Two tension springs 326 connect the base plate 301 and the shift frame 327. These tension springs 326 exert a spring force that pushes the shift frame 327 toward the base plate 301. This spring force pushes the shift frame 327 to the base plate 301 via the balls 325. The balls 325 roll to guide the shift frame 327 when the shift frame 327 is shifted in the pitch direction and the yaw direction with respect to the base plate 301.

Next, a description will be made of the image stabilizing system. Reference numerals 318p and 318y respectively denote a pitch shake sensor and a yaw shake sensor to detect a shake of the optical apparatus in the pitch direction and the yaw direction, and the sensors each include a gyro element that detects a rotation angle acceleration. Signals output from these shake sensors 318p and 318y are input to a CPU 354 as a controller. The CPU 354 provides integration and filter processing on the signals output from the shake sensors 318p and 318y depending on a shake of the optical apparatus so as to produce a correction signal for shifting the correcting lens 351 in a direction to reduce (correct) image blur due to the shake. The correction signal is input to an image stabilizing driver 356. The image stabilizing driver 356 energizes the pitch and yaw coils 322p and 322y in response to the correction signal. This generates a thrust force as an electromagnetic force between the pitch and yaw coils 322p and 322y and the pitch and yaw magnets 321p and 321y that shifts the correcting lens 351 together with the shift frame 327 in the pitch direction and the yaw direction so as to reduce the image blur.

As described above (as illustrated in FIG. 22), the correcting lens 351 held by the shift frame 327 is disposed in the opening 306 of the base plate 301 and in the shake correction space Sa. The operation of the image stabilizing system shifts the correcting lens 351 in the pitch direction and the yaw direction in the opening 306 of the base plate 301 and in the shake correction space Sa.

A diameter and depth of the shake correction space Sa is fixed irrespective of whether the stop blades 303 are open or closed. In practice, the driving ring is between the stop blades 303 and the shake correction space Sa, and the diameter of the shake correction space Sa basically depends on a diameter of a circle passing through the supported portion 303b (stop blade-supporting boss portion 307) of each stop blade 303, and does not depend on a size of the stop aperture A formed by the stop blades 303. The depth of the shake correction space Sa, as illustrated in FIG. 25 depends on the tilt α of the portion from the supported portion 303b to the intermediate portion of each stop blade 303 with respect to the opening plane 306a in the optical axis direction, and does not depend on the size of the stop aperture A. Thus, when the stop aperture A is narrowed down, (a front face of) the correcting lens 351 can be inserted into the concave space Sa without opening the stop aperture A to a fully opened aperture diameter or beyond that. Therefore, a shiftable amount (maximum shift amount) of the correcting lens 351 can be fixed irrespective of whether the stop blades 303 are open or closed (irrespective of the size of the stop aperture), and thereby the correcting lens 351 can be sufficiently shifted for a favorable image stabilization.

The shake correction space Sa is a space large extending from an end portion of a convex portion of the correcting lens 351 in a direction intersecting with the optical axis direction, preventing the correcting lens 351 and the shift frame 327 from contacting with the stop blades 303 when they are shifted.

Moreover, a description will be made of a case where the concave lens 353 having a concave surface facing the stop blades 303 is disposed on a front side (stop blade 303 side) of the aperture stop apparatus 310 of the optical apparatus on which the aperture stop apparatus 310 is mounted as illustrated in FIG. 22. In this case, the concave lens 353 and the correcting lens 351 can be arranged sufficiently close to each other in the optical axis direction although the stop cover plate 304, the stop blades 303 and the driving ring 302 are arranged therebetween. This achieves downsizing of the optical apparatus in the optical axis direction. This can also provide a large move range of one of the concave lens 353 and the correcting lens 351 (the aperture stop apparatus 310) relative to the other in an optical operation such as a magnification-varying operation. A length from the front face of the concave lens 353 to the correcting lens 351 in the optical axis direction is denoted by L.

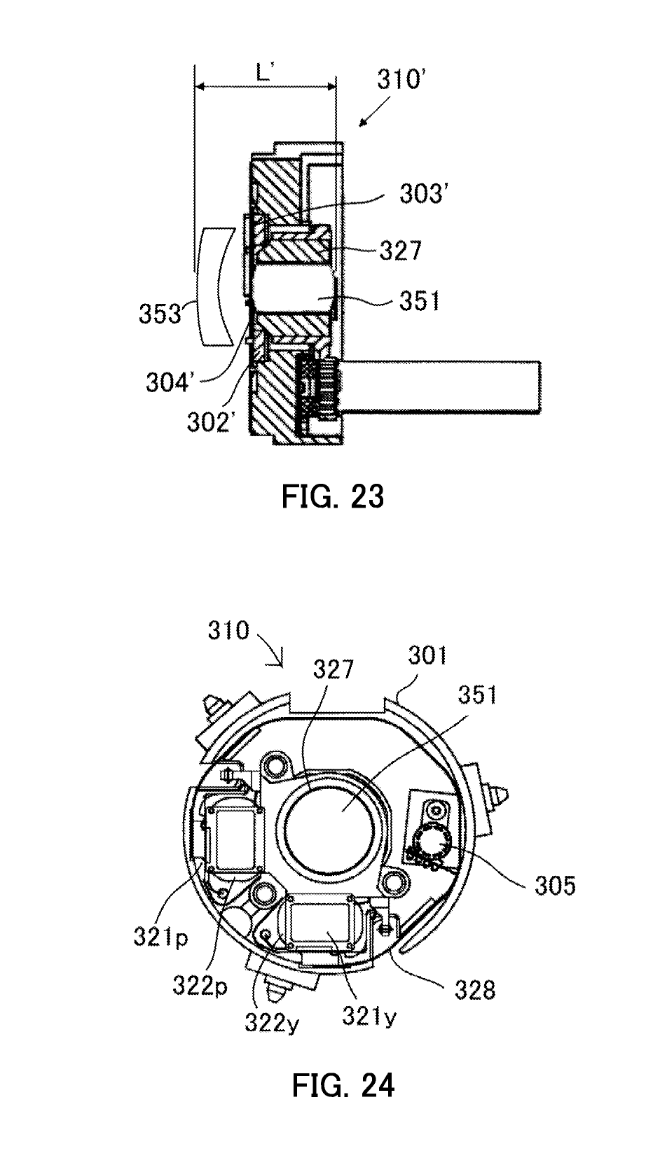

FIG. 23 illustrates an aperture stop apparatus 310′ in a comparative example. A driving ring 302′ in this comparative example is shaped such that a fixed aperture is formed in a center of a circular plate whose front and back faces are approximately flat. A stop blade 303′ and a stop cover plate 304′ are also formed flat. In this comparative example, it is obvious from FIG. 23 that the driving ring 302′ prevents the concave lens 353 from becoming sufficiently close to the correcting lens 351. Thus, the length from the front face of the concave lens 353 to the correcting lens 351 in the optical axis direction is a length L′ longer than the length L in FIG. 22. This makes it difficult to achieve downsizing in the optical axis direction of an optical apparatus on which the aperture stop apparatus 310′ in the comparative example is mounted, and also restricts the move range of one of the concave lens 353 and the correcting lens 351 (the aperture stop apparatus 310′) relative to the other.

As described above, in this embodiment, the shake correction space Sa is formed to have a size enough to allow the correcting lens 351 to shift therein with no need to largely open the stop blades 303. This enables the concave lens 353 adjacent to the aperture stop apparatus 310 in the optical axis direction to become close to the correcting lens 351 in the shake correction space Sa. Therefore, this embodiment provides an aperture stop apparatus that includes a light-quantity control mechanism and a shake correction mechanism (optical image stabilizing mechanism) and achieves miniaturization of an optical apparatus on which the aperture stop apparatus is mounted in an optical axis direction and downsizing thereof in a direction orthogonal to the optical axis direction.

It is noted that, although this embodiment described the case where a lens (the correcting lens 351) is used as the image stabilizing optical element, any optical element other than the lens may be used.

The light-quantity control apparatus described in (1) and (2) may be configured as follows.

(3) A light-quantity control apparatus according to (1), in which the curved path is formed between a concave portion of the first optical member and a convex portion of the second optical member, and a shake correction space between an end portion of the convex portion and the light-quantity control blade is formed on an aperture side of the curved path where the light-quantity control blade is supported.

(4) A light-quantity control apparatus according to (3), in which the shake correction space is a space largely expanding from the end portion of the convex portion in a direction intersecting with the optical axis direction.

(5) A light-quantity control apparatus according to any one of (1), (3) and (4), in which the shake correction unit includes a shake correction driver configured to shift at least one of the first and second optical members in a direction different from the optical axis direction.

(6) A light-quantity control apparatus according to (5), in which the blade driver includes a stop driver, and the stop driver and the shake correction driver are disposed at positions different from each other in a plane orthogonal to the optical axis direction in the apparatus body.

(7) A light-quantity control apparatus according to (6), in which the apparatus body includes a base member on which the light-quantity control blade and the blade driver are mounted, and the shake correction driver is disposed on an opposite side to a side of the base member on which the light-quantity control blade is disposed.

(8) A light-quantity control apparatus according to (7), in which: the light-quantity control blade includes a light-quantity controller to form a light-passing aperture, and a supported portion rotatably supported by the base member, and has such a shape that the light-quantity controller is located distant from the supported portion in the optical axis direction so as to form a concave space having a depth from the light-quantity control blade toward the light-passing aperture; and at least part of an optical material is disposed inside the concave space and configured to shift inside the concave space.

(9) A light-quantity control apparatus according to (2), in which a shiftable amount of the optical material that is shifted by the shake correction driver is fixed irrespective of a size of the light-passing aperture.

(10) A light-quantity control apparatus according to (2) or (9), in which the supported portion of the light-quantity control blade has a larger tilt with respect to the aperture plane in the optical axis direction than that of the light-quantity controller of the light-quantity control blade.

(11) A light-quantity control apparatus according to any one of (2), (9) and (10), in which the supported portion of the light-quantity control blade has a tilt with respect to the aperture plane in the optical axis direction, and the supported portion rotates around an axis titled with respect to the optical axis direction.

(12) A light-quantity control apparatus according to any one of (2), (9) and (11), in which the base member includes a fixed aperture, and the blade driver and the shake correction driver are disposed in a circumferential edge portion of the fixed aperture of the base member.

### Embodiment 6

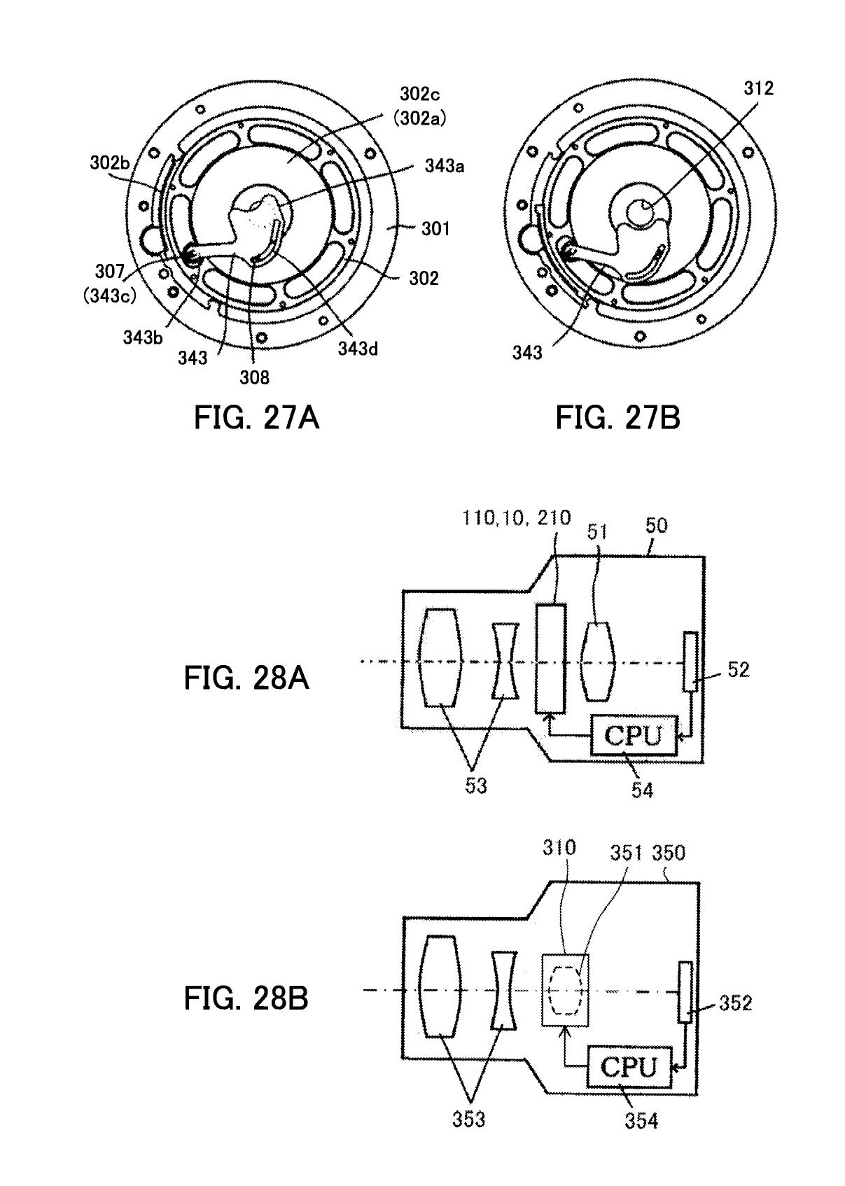

FIGS. 27A and 27B illustrate a light-quantity control mechanism in an aperture stop apparatus in Embodiment 6 of the present invention. In FIGS. 27A and 27B, components common to the present embodiment and Embodiment 5 are denoted by the same reference numerals as those in Embodiment 5, and a description thereof will be omitted. Although Embodiment 5 described the case where the size of the stop aperture formed by the plurality of stop blades 303 is changed so as to control the quantity of light, the quantity of light is controlled by rotating a single stop blade 343 in this embodiment.

The stop blade 343 includes a stop portion 343a to form a stop aperture (light-passing aperture), a supported portion 343b rotatably supported with respect to the base plate 301 and the driving ring 302, and an intermediate portion connecting the stop portion 343a and the supported portion 343b. A hole portion (concave portion) 343c into which the stop blade-supporting boss portion 307 formed in the base plate 301 is inserted is formed in the supported portion 343b. The stop blade 343 is rotatable about the supporting boss portion 307 and the hole portion 343c with respect to the base plate 301 and the driving ring 302.

In addition, a cam groove 343d in which the boss portion 308 provided to the driving ring 302 is inserted and that engages therewith is formed in the stop blade 343. Thus, as illustrated in FIGS. 27A and 27B, rotation of the driving ring 302 moves the boss portion 308 along the cam groove 343d and rotates the stop blade 343. The stop blade 343 is rotated between a position at which the stop portion 343a covers fixed apertures (only the fixed aperture 312 of the driving ring 302 is illustrated in FIG. 27A) formed in the base plate 301 and the driving ring 302 as illustrated in FIG. 27A and a position at which the stop portion 343a is completely retracted from a region facing the fixed aperture as illustrated in FIG. 27B. In this manner, the quantity of light passing through the fixed apertures is controlled.

The stop portion 343a is formed in a spherical surface shape (curved surface shape) having approximately the same curvature as that of the guide surface 302c of the domical wall portion 302a of the driving ring 302. Thus, the rotation of the stop blade 343 moves the stop portion 343a along the guide surface 302c.

In this embodiment as well, the supported portion 343b (and the intermediate portion) of the stop blade 343 has a tilt with respect to an opening plane of an opening of the base plate 301 in the optical axis direction. Thus a concave space having a depth from a supported portion (343b) side to a stop portion (343a) side in the optical axis direction and facing the fixed apertures is formed more inside than the stop blade 343 in the radial direction.

The light-quantity controller may rotate a single ND blade (light-quantity control blade) formed as an ND filter instead of the stop blade 343 so as to control the quantity of light. The ND filter is formed by, for example, mixing light-absorbing organic dye or pigment into a substrate, applying with light-absorbing organic dye or pigment, or depositing an evaporated film of metal and metallic compound. The ND filter having a curved surface shape is, however, preferably formed by mixing light-absorbing organic dye or pigment in a resin substrate.

### Embodiment 7

FIG. 28B illustrates a camera (video camera or still camera) as an optical apparatus on which the aperture stop apparatus 310 described in Embodiments 5 and 6 is mounted. Reference numeral 350 denotes a camera body (optical apparatus body). Reference numeral 351 denotes the correcting lens described above, and reference numeral 353 denotes the concave lens described above. The aperture stop apparatus 310 including the concave lens 353 and the correcting lens 351, and other illustrated lenses are included in an image pickup optical system. The image pickup optical system is housed in a lens barrel of the camera body 350. Reference numeral 352 denotes an image sensor. Reference numeral 354 denotes the CPU described above that controls operations of the aperture stop apparatus 310 (the stop driver 305 and the coils 322p and 322y included in the image stabilizing driver) and the image sensor 352. The aperture stop apparatus 310 may have a shutter function.

The lens barrel housing the image pickup optical system may be configured to be housed (retractable) in the camera body. When the lens barrel is retracted, the concave lens 353 is located close to the correcting lens 351 so as to achieve miniaturization of the camera in a retracted state as illustrated in FIG. 22A.

The aperture stop apparatus 310 is mountable not only on the camera illustrated in FIG. 28B but also on any other optical apparatus such as an interchangeable lens.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-128808, filed on Jun. 6, 2012, No. 2012-274970, filed on Dec. 17, 2012, No. 2012-285712, filed on Dec. 27, 2012, No. 2012-286350, filed on Dec. 27, 2012, and No. 2013-1553, filed on Jan. 9, 2013, which are hereby incorporated by reference herein in their entirety.

What is claimed is:

1. A light-quantity control apparatus comprising:
a light-quantity control blade movable along a curved path preformed between a convex lens surface of a first optical member and a concave lens surface of a second optical member; and
a blade driver configured to rotate the light-quantity control blade along the curved path.

2. A light-quantity control apparatus according to claim 1, wherein the blade driver includes a rotating member rotating about an optical axis to drive a plurality of the light-quantity control blades.

3. A light-quantity control apparatus according to claim 2,
wherein:
the light-quantity control blade includes:
a supported portion about which the light-quantity control blade rotates; and
a rotation restricting portion to restrict rotation of the light-quantity control blade about the supported portion, and
a facing direction of a supported surface of the supported portion and a surface direction of a restricting surface of the rotation restricting portion substantially intersect with each other (with a direction of the optical axis).

4. A light-quantity control apparatus according to claim 3, wherein, in the light-quantity control blade, a thickness of a portion including the supported portion other than a light-quantity control portion to control light-quantity is larger than that of the light-quantity control portion.

5. A light-quantity control apparatus according to claim 4, wherein the light-quantity control blade is formed by injection molding that injects a molten plastic to a cavity from a sprue of a mold through a gate to form a molded product, and
the light-quantity control blade includes a portion where the gate was formed in or adjacent to the supported portion.

6. A light-quantity control apparatus according to claim 2, wherein the rotating member includes gear tooth along the curved path.

7. A light-quantity control apparatus according to claim 1, further comprising a guide member bent along the curved path so as to guide the light-quantity control blade in the curved path,
wherein:
the guide member has a convex portion bent toward one side in an optical axis direction along the curved path, and
a pair of the guide members form, between their convex portions, a space to allow rotation of the light-quantity control blade.

8. A light-quantity control apparatus according to claim 7, further comprising a base member provided with an aperture portion,
wherein the paired guide members are a cover member to retain the light-quantity control blade to the base member and a sheet member to allow rotation of the light-quantity control blade being used as a shutter blade.

9. A light-quantity control apparatus according to claim 8, further comprising a shutter blade driver,
wherein the shutter blade driver has a rotation shaft tilting with respect to the optical axis direction and fixed to the base member.

10. A light-quantity control apparatus comprising:
a light-quantity control blade movable along a curved path preformed between a convex lens surface of a first optical member and a concave lens surface of a second optical member; and
a blade driver configured to rotate the light-quantity control blade along the curved path,
wherein the blade driver includes:
a rotating member configured to rotate the light-quantity control blade; and
a driver connected to an outer circumferential edge portion of the rotating member.

11. A light-quantity control apparatus according to claim 10, wherein the rotating member has a curved shape along the curved path.

12. A light-quantity control apparatus according to claim 10, further comprising a base member including a mounted portion to which the driver is mounted,
wherein the mounted portion is provided in a recess part of the outer circumferential edge portion of the base member, and
in the recess part, the rotating member and the driver face each other in an optical axis direction and are connected to each other.

13. A light-quantity control apparatus according to claim 10, further comprising a base member to which the driver is provided,
wherein the light-quantity control blade includes:
a light-quantity control portion to control quantity of light passing through a light-passing aperture; and
a supported portion rotatably supported with respect to the base member.

14. A light-quantity control apparatus provided with a light-passing aperture comprising:
a base member;
a light-quantity control blade including a light-quantity control portion to control quantity of light passing through the light-passing aperture and a supported portion rotatably supported with respect to the base member; and
a rotating member rotating with respect to the base member to rotate the light-quantity control blade,
wherein:
the light-quantity control blade is rotated by the rotating member along a curved path preformed between a convex lens surface of a first optical member and a concave lens surface of a second optical member,
when a direction orthogonal to an aperture plane of the light-passing aperture is defined as an optical axis direction, a concave space facing the light-passing aperture is formed more inside in a direction orthogonal to the optical axis direction than the light-quantity control blade,
the rotating member includes gear tooth serving as a driving mechanism, and
the gear tooth constitute part of a wall portion surrounding the concave space.

15. An optical apparatus comprising:
an optical apparatus body; and
a light-quantity control apparatus according to claim 1 which is housed in the body.

16. An optical apparatus comprising:
an optical apparatus body; and
a light-quantity control apparatus according to claim 10 which is housed in the body.

17. An optical apparatus comprising:
an optical apparatus body; and
a light-quantity control apparatus according to claim 14 which is housed in the body.
